(19) United States
(12) Patent Application Publication
(10) Pub. No.: US 2026/0250602 A1
(43) Pub. Date: Aug. 27, 2026

(54) CLEANING COMPOSITION HAVING IMPROVED VISCOSITY

(71) Applicant: Evonik Operations GmbH, Essen (DE)

(72) Inventors: Alexandra Trambitas, Alzenau (DE); Jochen Kleinen, Heinsberg (DE); Janine Breitenbach, Rodenbach (DE)

(73) Assignee: Evonik Operations GmbH, Essen (DE)

(21) Appl. No.: 19/541,475

(22) Filed: Feb. 17, 2026

(30) Foreign Application Priority Data
Feb. 21, 2025 (DE) 102025106719.8

(51) Int. Cl. C11D 1/83; C11D 1/29

(52) U.S. Cl. CPC C11D 1/83; C11D 1/29

(57) ABSTRACT

A liquid cleaning composition R has improved viscosity properties. The liquid cleaning composition R is particularly, but not exclusively, suitable in water-based applications, such as personal care and the washing of textiles and dishware, in particular as hand dishwashing detergent. At least one glucolipid G can be used for increasing the viscosity of a liquid cleaning composition, preferably the liquid cleaning composition R. A process treats a substrate S using the liquid cleaning composition R.

### CROSS-REFERENCE TO RELATED APPLICATIONS

This application claims priority to German Patent Application No. DE 10 2025 106 719.8, filed on Feb. 21, 2025, the content of which is hereby incorporated by reference in its entirety.

### BACKGROUND OF THE INVENTION

### Field of the Invention

The present invention relates to a liquid cleaning composition R having improved viscosity properties. The liquid cleaning composition R is particularly, but not exclusively, suitable in water-based applications, such as personal care and the washing of textiles and dishware, in particular as hand dishwashing detergent. The present invention accordingly also relates to the use of at least one glucolipid G for increasing the viscosity of a liquid cleaning composition, preferably the liquid cleaning composition R. The invention also relates to a process for treating, preferably for washing and/or rinsing, a substrate S using the liquid cleaning composition R.

### Description of Related Art

The prior art discloses hand-mild washing compositions having good foam properties based on biosurfactants. These washing compositions can be used for personal care or for washing textiles, hard surfaces, or also as hand dishwashing detergent.

WO 2019/154970 A1 describes detergent compositions and personal care compositions comprising glucolipids.

WO 2011/120776 A1 describes a hand-mild, foaming, aqueous cleaning composition based on the combination of various surfactants with biosurfactants such as rhamnolipids or sophorolipids.

WO 2014/118095 A1 discloses a foaming washing composition comprising a synthetic anionic surfactant, a glycolipid surfactant and optionally an encapsulated active ingredient. This washing composition is suitable for personal care or for hand washing of laundry or dishware, especially when used in water with a high proportion of calcium ions (“hard” water) or in service water.

Service water is industrial water that does not meet the minimum requirements for potable water, but is used in technical, commercial, agricultural or domestic applications.

Especially with cleaning agents that can be used as hand dishwashing detergents, it is also desirable for this to have a sufficient hand mildness (also referred to as “skin mildness”).

WO 2014/173659 A1 describes corresponding cleaning agents for laundry or dishes in which rhamnolipids are used to adjust the viscosity. These cleaning agents are characterized by an advantageous dispersion.

WO 2019/219303 A1 and WO 2019/219531 A1 describe cleaning compositions containing rhamnolipids and having advantageous viscosity properties.

Although the described cleaning agents, which comprise rhamnolipids, show good dispersion properties, foam properties, hand mildness and viscosity, there is always a need for cleaning agents that exhibit even better properties in terms of dispersion properties, foam properties, hand mildness and/or viscosity.

### SUMMARY OF THE INVENTION

An object of the present invention was to provide such a cleaning agent.

A further object of the invention was to provide a cleaning composition suitable in particular as a hand dishwashing detergent, which comprises in particular an encapsulated active ingredient (“benefit agent”) and has improved dispersion compared to those of the prior art, in particular compared to those according to WO 2014/173659 A1, especially when used in hard water or service water.

A further object of the invention was that of providing a cleaning agent for laundry or dishware, in particular a hand dishwashing detergent, a particular feature of which is improved foam properties compared to those of the prior art, in particular compared to those according to WO 2014/173659 A1, especially when used in hard water or service water.

A further object of the invention was that of providing a cleaning agent for laundry or dishware, in particular a hand dishwashing detergent, a particular feature of which is an improved sensation of mildness compared to those of the prior art, in particular compared to those according to WO 2014/173659 A1, especially when used in hard water or service water.

Lastly, a further object of the invention was that of providing a liquid cleaning agent, for example for laundry or dishware, in particular a hand dishwashing detergent, a particular feature of which is an advantageous rheology, in particular improved viscosity properties, compared to those of the prior art, in particular compared to those according to WO 2019/219303 A1. To be specific, the cleaning compositions disclosed in WO 2019/219303 A1 did exhibit a viscosity suitable precisely for hand dishwashing detergents, which accommodates the user's requirement for a “thick” dish detergent, even without the addition thereto of additional thickeners such as the “HASE” (=“hydrophobically modified alkali soluble emulsion”) polymers described in WO 2019/219303 A1. This improved viscosity is also only displayed over a relatively small pH range (pH 4 to pH 5.75) in WO 2019/219303 A1, and it is desirable to broaden this range.

It was accordingly also an object of the present invention to provide a liquid cleaning composition which can be used in particular as dish detergent or laundry detergent, for example hand dishwashing detergent or hand wash laundry detergent, which also exhibits a higher viscosity and hence “thickness” over a relatively broad pH range and without additional thickeners (such as the “HASE” polymers described in WO 2019/219303 A1). It is intended that this liquid cleaning agent be based on biosurfactants.

### DETAILED DESCRIPTION OF THE INVENTION

### 1. Liquid Cleaning Composition R According to the Invention

Surprisingly, a liquid cleaning composition R which achieves the abovementioned objects has now been found.

The liquid cleaning composition R according to the invention comprises
a) a surfactant combination T_{Comb}, the proportion of the surfactant combination T_{Comb} in the liquid cleaning composition R preferably lying in the range from 5% by weight to 70% by weight, based on the total weight of the liquid cleaning composition R,
   wherein the surfactant combination T_{Comb} comprises, and preferably consists of, the following constituents i., ii., iii.:
      i. at least one amphoteric surfactant T_{Amph},
      ii. at least one glucolipid G,
      iii. at least one surfactant T* different from G, where T* is selected from the group consisting of nonionic and anionic surfactants and T* is preferably a nonionic surfactant,
wherein the proportion of all glucolipids G in the surfactant combination T_{Comb} lies in the range from 1% by weight to 95% by weight, preferably in the range from 1% by weight to 70% by weight, more preferably in the range from 25% by weight to 50% by weight, most preferably in the range from 5% by weight to 25% by weight, based in each case on the total weight of the surfactant combination T_{Comb},
wherein the proportion of all amphoteric surfactants T_{Amph} in the surfactant combination T_{Comb} lies in particular in the range from 0.5% by weight to 10% by weight, preferably in the range from 0.75% by weight to 5% by weight, most preferably in the range from 1% by weight to 4% by weight, based in each case on the total weight of the surfactant combination T_{Comb},
b) water;
c) at least one polymer P_{C}, where P_{C} is selected from the group consisting of alkoxylated polyamine and polyester soil release polymer, wherein the proportion of all polymers P_{C} lies preferably in the range from 0.1% by weight to 15% by weight, preferably in the range from 0.1% by weight to 10% by weight, based in each case on the total weight of the liquid cleaning composition R,
and wherein the liquid cleaning composition R has a pH in the range from 3.0 to 6.5, in particular 3.5 to 6.5, more preferably 4.0 to 6.5, more preferably 4.25 to 6.5, more preferably 4.5 to 6.5, more preferably 4.75 to 6.5, more preferably still 5.0 to 6.5, yet more preferably still 5.25 to 6.5, yet more preferably still 5.5 to 6.5, yet more preferably still 5.75 to 6.5, yet more preferably still 5.80 to 6.5, yet more preferably still 6.0 to 6.5, yet more preferably still 6.1 to 6.4, yet more preferably still 6.2 to 6.3.

The liquid cleaning composition R according to the invention comprises water. The proportion of water in R lies preferably in the range from 30% by weight to 95% by weight, more preferably in the range from 40% by weight to 88% by weight, more preferably still in the range from 50% by weight to 80% by weight, yet more preferably still in the range from 60% by weight to 75% by weight, based in each case on the total weight of the liquid cleaning composition R.

In a preferred embodiment, the liquid cleaning composition R according to the invention comprises
a) a surfactant combination T_{Comb}, the proportion of the surfactant combination T_{Comb} in the liquid cleaning composition R preferably lying in the range from 5% by weight to 70% by weight, based on the total weight of the liquid cleaning composition R,
   wherein the surfactant combination T_{Comb} consists of the following constituents i., ii., iii.:
      i. at least one amphoteric surfactant T_{Amph},
      ii. at least one glucolipid G,
      iii. at least one surfactant T* different from G, where T* is selected from the group consisting of nonionic and anionic surfactants and T* is preferably a nonionic surfactant,
wherein the proportion of all glucolipids G in the surfactant combination T_{Comb} lies in the range from 1% by weight to 95% by weight, preferably in the range from 1% by weight to 70% by weight, more preferably in the range from 25% by weight to 50% by weight, most preferably in the range from 5% by weight to 25% by weight, based in each case on the total weight of the surfactant combination T_{Comb},
wherein the proportion of all amphoteric surfactants T_{Amph} in the surfactant combination T_{Comb} lies in particular in the range from 0.5% by weight to 10% by weight, preferably in the range from 0.75% by weight to 5% by weight, most preferably in the range from 1% by weight to 4% by weight, based in each case on the total weight of the surfactant combination T_{Comb},
b) water;
c) at least one polymer P_{C}, where P_{C} is selected from the group consisting of alkoxylated polyamine and polyester soil release polymer, wherein the proportion of all polymers P_{C} lies preferably in the range from 0.1% by weight to 15% by weight, more preferably in the range from 0.1% by weight to 10% by weight, based in each case on the total weight of the liquid cleaning composition R,
and wherein the liquid cleaning composition R has a pH in the range from 3.0 to 6.5, in particular 3.5 to 6.5, more preferably 4.0 to 6.5, more preferably 4.25 to 6.5, more preferably 4.5 to 6.5, more preferably 4.75 to 6.5, more preferably still 5.0 to 6.5, yet more preferably still 5.25 to 6.5, yet more preferably still 5.5 to 6.5, yet more preferably still 5.75 to 6.5, yet more preferably still 5.80 to 6.5, yet more preferably still 6.0 to 6.5, yet more preferably still 6.1 to 6.4, yet more preferably still 6.2 to 6.3.

The liquid cleaning compositions R according to the invention are distinguished by properties that are improved compared to the cleaning compositions of the prior art, in particular improved foam properties, improved hand mildness and improved dispersion properties, in particular when used in service water and/or water comprising Ca²⁺ ions. The liquid cleaning composition R therefore affords outstanding aesthetic and sensory properties even when used in water having a lower quality than potable water. Through the formation of a pronounced, stable foam, aesthetically disadvantageous constituents of the washing water are covered and the user is encouraged as a result to interact with the washing water. In embodiments in which the liquid cleaning composition R comprises active ingredient capsules W_{K} comprising at least one active ingredient B, there is a further advantage in that the active ingredient B is then at least partially released, which further improves the sensory properties.

The present invention accordingly also relates to a wash solution W_{R} comprising the liquid cleaning composition R according to the invention, wherein the total concentration of all Mg²⁺ and Ca²⁺ ions in the water is preferably ≥1 mmol/l, more preferably is ≥10 mmol/l, yet more preferably is ≥20 mmol/l, yet more preferably is ≥30 mmol/l, yet more preferably is ≥40 mmol/l, yet more preferably is ≥50 mmol/l, yet more preferably is ≥60 mmol/l, yet more preferably is ≥70 mmol/l, yet more preferably is ≥80 mmol/l, yet more preferably is ≥90 mmol/l. The wash solution is particularly foaming and is characterized by a particularly stable foam.

The liquid cleaning compositions R according to the invention are advantageously used in water-based applications, for example in personal care (as a shower gel or shampoo), as laundry detergent for washing clothing or as a dishwashing detergent (for example as hand dishwashing detergent).

Preferably, the liquid cleaning composition R is used as laundry detergent for washing clothing or as dishwashing detergent (for example as hand dishwashing detergent), particularly preferably as hand dishwashing detergent. “Hand dishwashing detergent” (or “hand dishwashing agent”) is any cleaning agent that can be used for rinsing or washing dishware. It may also be referred to as “hand dish wash detergent”.

The liquid cleaning compositions R according to the invention have different preferred viscosity ranges depending on the field of use.

For liquid laundry detergents, the preferred viscosity range lies in the range from 250 cPs to 1000 cPs, preferably in the range from 300 cPs to 650 cPs. For liquid hand dishwashing detergents, the preferred viscosity range lies in the range from 400 cPs to 4000 cPs, preferably in the range from 800 cPs to 3500 cPs.

In the liquid cleaning composition R according to the invention, the proportion of the surfactant combination T_{Comb} in the liquid cleaning composition R preferably lies in the range from 5% by weight to 70% by weight, based on the total weight of the liquid cleaning composition R. In a preferred embodiment, the proportion of the surfactant combination T_{Comb} in the liquid cleaning composition R lies in the range from 5% by weight to 60% by weight, preferably in the range from 5% by weight to 50% by weight, more preferably in the range from 7.5% by weight to 30% by weight, more preferably still in the range from 7.5% by weight to 25% by weight, yet more preferably still in the range from 8% by weight to 25% by weight, most preferably in the range from 8% by weight to 20% by weight, based in each case on the total weight of the liquid cleaning composition R.

In the embodiments of the present invention in which the liquid cleaning composition R is a detergent for clothing or hard surfaces, in particular a hand dishwashing detergent, the proportion of the surfactant combination T_{Comb} in the liquid cleaning composition R according to the invention is preferably selected such that the total weight of the surfactant combination T_{Comb} lies in the range from 5% by weight to 70% by weight, more preferably in the range from 5% by weight to 60% by weight, more preferably still in the range from 5% by weight to 40% by weight, most preferably in the range from 5% by weight to 35% by weight, based in each case on the total weight of the liquid cleaning composition R.

In the embodiments of the present invention in which the liquid cleaning composition R is a personal cleansing composition, in particular for human or animal skin or human or animal hair, the proportion of the surfactant combination T_{Comb} in the liquid cleaning composition R according to the invention is preferably selected such that the total weight of the surfactant combination T_{Comb} lies in the range from 5% by weight to 70% by weight, more preferably in the range from 5% by weight to 60% by weight, more preferably still in the range from 10% by weight to 40% by weight, most preferably in the range from 15% by weight to 35% by weight, based in each case on the total weight of the liquid cleaning composition R.

In the embodiments of the present invention in which the liquid cleaning composition R is a cosmetic product, the proportion of the surfactant combination T_{Comb} in the liquid cleaning composition R according to the invention is preferably selected such that the total weight of the surfactant combination T_{Comb} lies in the range from 5% by weight to 30% by weight, more preferably in the range from 5% by weight to 15% by weight, based in each case on the total weight of the liquid cleaning composition R.

In a further aspect of the present invention, it relates to a process for treating a substrate S, in particular selected from woven fabrics, nonwovens, hard surfaces, preferably dishware.

This process preferably comprises the following steps
(i) providing a wash solution W_{R}, in particular by mixing R and water, wherein the total concentration of all Mg²⁺ and Ca²⁺ ions in the water is preferably ≥1 mmol/l, more preferably is ≥10 mmol/l, yet more preferably is ≥20 mmol/l, yet more preferably is ≥30 mmol/l, yet more preferably is ≥40 mmol/l, yet more preferably is ≥50 mmol/l, yet more preferably is ≥60 mmol/l, yet more preferably is ≥70 mmol/l, yet more preferably is ≥80 mmol/l, yet more preferably is ≥90 mmol/l,
(ii) contacting the substrate S with W_{R}.

In the embodiments of the process according to the invention in which R comprises active ingredient capsules W_{K} comprising at least one active ingredient B, shear forces are preferably exerted on the active ingredient capsules W_{K} in step (ii), so that at least some of the active ingredient B emerges into the wash solution W_{R}.

The process is preferably conducted in a container, in particular selected from bathtub, bucket, washing tub, sink. The invention is particularly suitable for applications in which the container has an opening, such as for example a bathtub, a sink, a bucket, a washing tub, in which the user dips at least part of the body into the wash solution W_{R} in order to clean the substrate S, where the substrate S is preferably the body of the user or a woven fabric, nonwoven, a hard surface, preferably dishware, and the substrate S is preferably dishware that is washed by hand.

The substrate S is in particular selected from an object and a part of the human or animal body; preferably, S is an object. Preferred objects are selected from woven fabrics, nonwovens, objects with hard surfaces, preferably dishware.

However, the liquid cleaning composition R can also be used for personal care, for example as shampoo. Preferred parts of the human or animal body are then the teeth, hair or skin.

In a further aspect of the present invention, it relates to the use of at least one glucolipid G for increasing the viscosity of a liquid cleaning composition having a pH in the range from 4.0 to 6.5, in particular 4.25 to 6.5, preferably 4.5 to 6.5, more preferably 4.75 to 6.5, more preferably still 5.0 to 6.5, yet more preferably still 5.25 to 6.5, yet more preferably still 5.5 to 6.5, yet more preferably still 5.75 to 6.5, yet more preferably still 5.80 to 6.5, yet more preferably still 6.0 to 6.5, yet more preferably still 6.1 to 6.4, yet more preferably still 6.2 to 6.3.

The liquid cleaning composition is in this case in particular the liquid cleaning composition R according to the invention.

However, the liquid cleaning composition R according to the present invention is distinguished first and foremost also in that it comprises biosurfactants and exhibits a viscosity over a broader pH range than comparable cleaning compositions of the prior art, for example those of WO 2019/219303 A1, without the need to use the thickeners described in WO 2019/219303 A1 such as for example the HASE polymers. In the latter case, a thickness desired for a hand dishwashing detergent can be achieved only in the pH range from 4 to 5.75, whereas the liquid cleaning compositions R according to the invention have a comparable thickness at a pH of 6.0.

### 1.1 Surfactant Combination T_{Comb}

The liquid cleaning composition R according to the invention comprises a surfactant combination T_{Comb}. The amount of the surfactant combination T_{Comb} in the liquid cleaning composition R preferably lies in the range from 5% by weight to 70% by weight, based on the total weight of the liquid cleaning composition R. In a preferred embodiment, the proportion of the surfactant combination T_{Comb} in the liquid cleaning composition R lies in the range from 5% by weight to 60% by weight, preferably in the range from 5% by weight to 50% by weight, more preferably in the range from 7.5% by weight to 30% by weight, more preferably still in the range from 7.5% by weight to 25% by weight, yet more preferably still in the range from 8% by weight to 25% by weight, most preferably in the range from 8% by weight to 20% by weight, based in each case on the total weight of the liquid cleaning composition R.

The liquid cleaning composition R according to the invention optionally comprises active ingredient capsules W_{K} comprising at least one active ingredient B.

The surfactant combination T_{Comb} comprises, and preferably consists of, the following constituents i., ii., iii.:
i. at least one amphoteric surfactant T_{Amph},
ii. at least one glucolipid G,
iii. at least one surfactant T* different from G, where T* is selected from the group consisting of nonionic and anionic surfactants and T* is preferably a nonionic surfactant.

The proportion of all glucolipids G in the surfactant combination T_{Comb} lies in the range from 1% by weight to 95% by weight, preferably in the range from 1% by weight to 50% by weight, more preferably in the range from 2.5% by weight to 50% by weight, most preferably in the range from 5% by weight to 25% by weight, based in each case on the total weight of the surfactant combination T_{Comb}.

The proportion of all amphoteric surfactants T_{Amph} in the surfactant combination T_{Comb} lies in particular in the range from 0.5% by weight to 10% by weight, preferably in the range from 0.75% by weight to 5% by weight, most preferably in the range from 1% by weight to 4% by weight, based in each case on the total weight of the surfactant combination T_{Comb}. The amphoteric surfactants T_{Amph} are part of the surfactant combination T_{Comb}.

### 1.1.1 Surfactant T_{Amph}

Preferred amphoteric (synonymous with “zwitterionic”) surfactants T_{Amph} for the purposes of the invention are those surface-active compounds bearing at least one quaternary ammonium group and at least one —COO⁺ or —SO₃ group in the molecule. Further suitable amphoteric surfactants are the group of amphoacetates and amphodiacetates, especially for example coco- or laurylamphoacetates or -diacetates, the group of the amphopropionates and amphodipropionates and the group of the amino acid-based surfactants such as acyl glutamates, especially disodium cocoyl glutamate and sodium cocoyl glutamate, acyl glycinates, especially cocoyl glycinates, and acyl sarcosinates, especially ammonium lauroyl sarcosinate and sodium cocoyl sarcosinate. Zwitterionic surfactants of the amine oxide type, in particular selected from lauryldimethylamine oxide, N-cocoalkyl-N,N-dimethylamine oxide and N-tallow fatty alkyl-N,N-dihydroxyethylamine oxide, preferably lauryldimethylamine oxide, are likewise suitable.

Preferred amphoteric surfactants T_{Amph} comprise betaine, alkyldimethylbetaine, sulfobetaine. Yet more preferred are betaines such as N-alkyl-N,N-dimethylammonium glycinates, for example cocoalkyldimethylammonium glycinate, N-acylaminopropyl-N,N-dimethylammonium glycinate, for example cocoacylaminopropyldimethylammonium glycinate, C₁₂-C₁₈-alkyldimethylacetobetaine, cocoamidopropyldimethylacetobetaine, 2-alkyl-3-carboxymethyl-3-hydroxyethylimidazoline and sulfobetaines each having 8 to 18 carbon atoms in the alkyl or acyl group. Preference is given here to cocoacylaminoethylhydroxyethylcarboxymethyl glycinates.

Particularly preferred amphoteric surfactants T_{Amph} are betaine surfactants such as alkyl- or alkylamidopropylbetaines, particularly preferably cocamidopropylbetaine as most preferred betaine surfactant, or amine oxides, in particular selected from lauryldimethylamine oxide, N-cocoalkyl-N,N-dimethylamine oxide and N-tallow fatty alkyl-N,N-dihydroxyethylamine oxide, preferably lauryldimethylamine oxide.

“Cocamidopropylbetaine” is understood in particular to mean a compound of the structural formula (XIII), where R is a saturated or unsaturated alkyl radical having 3 to 24 carbon atoms.

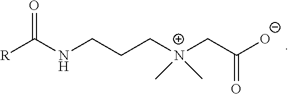

### (XIII)

In structural formula (XIII), the radical R—C(═O)— is more preferably selected from the fatty acyl radicals of the following acids: caproic acid, caprylic acid, capric acid, lauric acid, myristic acid, palmitic acid, stearic acid, oleic acid, linoleic acid, linolenic acid, arachidic acid, gadoleic acid.

Most preferably, the radical R is an unbranched, saturated alkyl radical having 11 carbon atoms, i.e. the radical R—C(═O)— is the fatty acyl radical of lauric acid.

### 1.1.2 Biosurfactants

Glucolipids G, and also rhamnolipids and sophorolipids, are biosurfactants and, as with processes for their synthesis, are known to those skilled in the art, for example from WO 2019/154970 A1, EP 0 499 434 A1 (glucolipids are called “glucoselipids” in this document), DE 196 48 439 A1, DE 196 00 743 A1. EP 3 061 442 A2, WO 03/006146 A1, US 2008/0213194 A1, JP HO1-304034 A1, CN 1337439 A describe processes for preparing glucolipids and rhamnolipids. WO 03/002700 A1, U.S. Pat. Nos. 4,305,961 A, 7,556,654 B1 describe processes for preparing sophorolipids.

Rhamnolipids, sophorolipids and glucolipids fall under the general class of Glycolipids.

Within the context of the present invention, it has surprisingly been found that glucolipids G lead, in the liquid cleaning compositions R according to the invention, to improved dispersion properties, and in particular, in embodiments in which R comprises active ingredient capsules, enable stable dispersions of active ingredient capsules W_{K} in liquid cleaning agents R, in particular hand dishwashing detergents, compared to the stabilization action that can be achieved with rhamnolipids or sophorolipids.

It has furthermore surprisingly been found that glucolipids G, compared to rhamnolipids or also sophorolipids, in the liquid cleaning compositions R according to the invention, lead to improved foam properties, improved hand mildness, in particular when used in service water and/or water comprising Ca²⁺ ions.

The liquid cleaning compositions R comprise glucolipids G. Optionally, the liquid cleaning compositions R may additionally comprise at least one further biosurfactant, preferably selected from rhamnolipids and sophorolipids, more preferably still rhamnolipids and sophorolipids.

### 1.1.2.1 Glucolipid G

Within the context of the invention, the glucolipid G in particular has a structure selected from the following structural formulae (I), (XIV), more preference being given to a structure of structural formula (I), and more preference still to the following structural formula (IU):

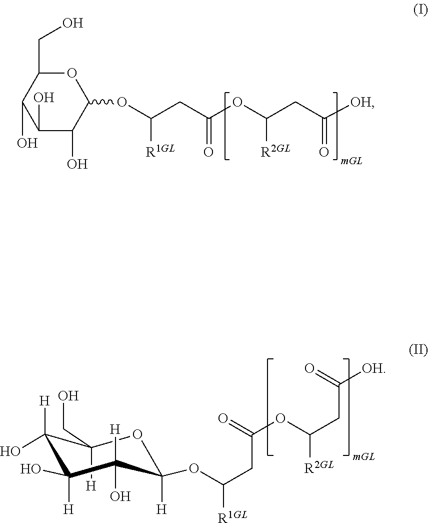

In the structural formulae (I) and (II), mGL=3, 2, 1 or 0, preferably 1 or 0.

The radicals R^{1GL} and R^{2GL} are each independently an organic radical having 2 to 24, preferably 5 to 20, more preferably 7 to 15, more preferably still 7, carbon atoms.

R^{1GL} and R^{2GL} are preferably each independently selected from the group consisting of
i. optionally substituted alkyl radicals having 2 to 24, preferably 5 to 20, more preferably 7 to 15, more preferably still 7, carbon atoms, with substitution with at least one, in particular exactly one, hydroxy radical being the preferred substitution;
ii. optionally substituted alkenyl radicals having 2 to 24, preferably 5 to 20, more preferably 7 to 15, more preferably still 7, carbon atoms, with substitution with at least one, in particular exactly one, hydroxy radical being the preferred substitution.

R^{1GL} and R^{2GL} are more preferably each independently selected from the group consisting of pentenyl, heptenyl, nonenyl, undecenyl, tridecenyl and —(CH₂)ₒ—CH₃, where o=1 to 23, preferably 4 to 12. R^{1GL} and R^{2GL} are most preferably each n-heptyl.

In cases where mGL=0, different glucolipids are abbreviated using the following nomenclature: “GL-CX” means glucolipids of the general formulae (I) or (II) in which mGL=0 and in which the radical R^{1GL}=—(CH₂)ₒ—CH₃ where o=X−4.

In cases where mGL=1, different glucolipids are abbreviated using the following nomenclature: “GL-CXCY” means glucolipids of the general formulae (I) or (II) in which mGL=1 and in which one of the radicals R^{1GL} and R^{2GL}=—(CH₂)ₒ—CH₃ where o=X−4 and the other of the radicals R^{1GL} and R^{2GL}=—(CH₂)ₒ—CH₃ where o=Y−4.

This nomenclature therefore does not distinguish between “CXCY” and “CYCX”.

If one of the indices X and/or Y is supplemented with “:Z”, this means that the respective radical R^{1GL} or R^{2GL} is an unbranched, unsubstituted hydrocarbon radical having X−3 or Y−3 carbon atoms and Z double bonds.

The wavy bond in the structural formula (I) [and also in the structural formula (III) described below] means that the respective substituent is oriented axially or equatorially, preferably equatorially.

Alkyl radicals can be linear or branched. Alkenyl radicals can be linear or branched and preferably have one to three double bonds.

In cases where the compounds of the structural formulae (I) and (II) have more than one radical R^{2GL}, the radicals R^{2GL} may be identical or different.

Alternatively or in addition, the glucolipids G used may also be compounds (so-called “di-glucolipids”) of the following general structural formula (XIV):

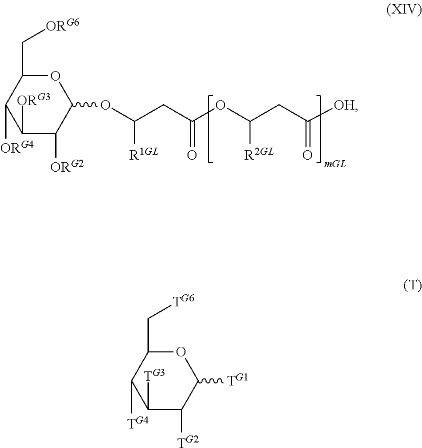

In the structural formula (XIV), the following applies:

In the structural formula (XIV), mGL=3, 2, 1 or 0, preferably 1 or 0.

The radicals R^{1GL} and R^{2GL} are identical or different and in each case are an organic radical having 2 to 24 carbon atoms, preferably 5 to 20, more preferably 7 to 15, more preferably still 7, carbon atoms,
wherein the radicals R^{1GL} and R^{2GL} are preferably independently selected from the group consisting of optionally substituted alkyl radicals having 2 to 24, more preferably 5 to 20, more preferably still 7 to 15, yet more preferably still 7, carbon atoms, with hydroxy-substituted alkyl radicals being preferred substituted alkyl radicals,
optionally substituted alkenyl radicals having 2 to 24, preferably 5 to 20, more preferably still 7 to 15, carbon atoms, yet more preferably still 7 carbon atoms, with hydroxy-substituted alkenyl radicals being preferred substituted alkenyl radicals,
wherein the radicals R^{1GL} and R^{2GL} are more preferably independently selected from the group consisting of pentenyl, heptenyl, nonenyl, undecenyl, tridecenyl and —(CH₂)ₒCH₃, where o=1 to 23, preferably 4 to 12. R^{1GL} and R^{2GL} are most preferably each n-heptyl.
   One of the radicals R^{G2}, R^{G3}, R^{G4} and R^{G6} is a radical of the general structural formula (T) and the three remaining radicals from R^{G2}, R^{G3}, R^{G4} and R^{G6} are in each case hydrogen.

In the general structural formula (T), one of T^{G1}, T^{G2}, T^{G3}, T^{G4} and T^{G6}, preferably T^{G1}, is a direct bond to the structure (XIV), while the other four from T^{G1}, T^{G2}, T^{G3}, T^{G4} and T^{G6} are in each case hydroxy, with T^{G1} preferably being a direct bond to the structure (XIV), while T^{G2}, T^{G3}, T^{G4} and T^{G6} are in each case hydroxy.

The wavy bond in structural formulae (XIV) and (T) means that the respective radical is in the axial or equatorial position, preferably equatorial position, with respect to the sugar ring.

In the embodiments in which compounds of the structural formula (XIV) have more than one radical R^{2GL}, these radicals R^{2GL} may be identical or different.

The glucolipid G according to the invention may also be present as salt. In this embodiment, it is preferable for the glucolipid G to be present as salt in which the cation is selected from the group consisting of Li⁺, Na⁺, K⁺, Mg²⁺, Ca²⁺, Al³⁺, NH₄⁺, ammonium ions, where these may be primary, secondary or tertiary ammonium ions. Particularly preferred cations are selected from the group consisting of Na⁺, K⁺, NH₄⁺ and the triethanolammonium cation.

Preferred ammonium cations are selected from the group consisting of tetramethylammonium, tetraethylammonium, tetrapropylammonium, tetrabutylammonium, [(2-hydroxyethyl)trimethylammonium](=choline) and cations of 2-aminoethanol (“MEA”), of diethanolamine (“DEA”), of 2.2′,2″-nitrilotriethanol (“TEA”), of 1-aminopropan-2-ol, of ethylenediamine, of diethylenetriamine, of triethylenetetramine, of tetraethylenepentamine, of 1,4-diethylenediamine, of piperazine, of aminoethylpiperazine and of aminoethylethanolamine.

Mixtures of the abovementioned cations may also be used as cations of the glucolipid salts. 5 The proportion of all glucolipids G in the surfactant combination T_{Comb} lies in the range from 1% by weight to 95% by weight, preferably in the range from 1% by weight to 70% by weight, more preferably in the range from 2.5% by weight to 50% by weight, most preferably in the range from 5% by weight to 25% by weight, based on the total weight of T_{Comb}.

### 1.1.2.2 Rhamnolipids

Rhamnolipids are in particular compounds of the following structural formula (III) and salts thereof, preferably compounds of the following structural formula (IV) and salts thereof:

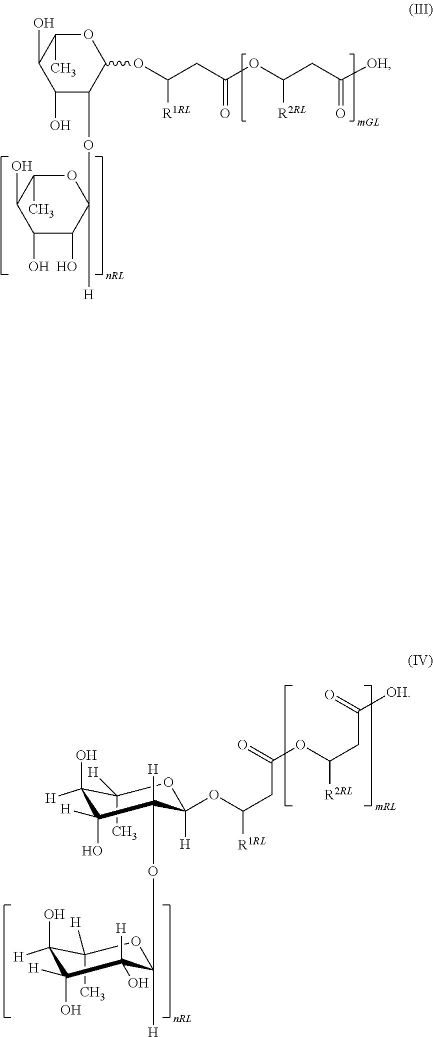

In the structural formulae (III) and (IV), mRL=2, 1 or 0, preferably 1 or 0.

In the structural formulae (III) and (IV), nRL=1 or 0.

The radicals R^{1RL} and R^{2RL} are each independently an organic radical having 2 to 24, preferably 5 or 13, carbon atoms.

R^{1RL} and R^{2RL} are preferably each independently selected from the group consisting of
i. optionally substituted alkyl radicals having 2 to 24, preferably 5 to 13, carbon atoms, with substitution with at least one, in particular exactly one, hydroxy radical being the preferred substitution;
ii. optionally substituted alkenyl radicals having 2 to 24, preferably 5 to 13, carbon atoms, with substitution with at least one, in particular exactly one, hydroxy radical being the preferred substitution.

R^{1RL} and R^{2RL} are more preferably each independently selected from the group consisting of pentenyl, heptenyl, nonenyl, undecenyl, tridecenyl and —(CH₂)ₒ—CH₃, where o=1 to 23, preferably 4 to 12.

For nRL=1, the glycosidic bond between the two rhamnose units is preferably in the α configuration. The optically active carbon atoms of the fatty acid radicals are preferably R-enantiomers (e.g. (R)-3-{(R)-3-[2-O-(α-L-rhamnopyranosyl)-α-L-rhamnopyranosyl]oxydecanoyl}oxydecanoate).

“Di-rhamnolipids” (“Di-RL”) are those compounds of the structural formulae (III) and (IV) or salts thereof, for which nRL=1.

“Mono-rhamnolipids” (“Mono-RL”) are those compounds of the structural formulae (III) and (IV) or salts thereof, for which nRL=0.

Different rhamnolipids are abbreviated using the following nomenclature: “diRL-CXCY” means di-rhamnolipids of the structural formulae (III) and (IV) in which one of the radicals R^{1RL} and R^{2RL}=—(CH₂)ₒ—CH₃ where o=X−4 and the other of the radicals R^{1RL} and R^{2RL}=—(CH₂)ₒ—CH₃ where o=Y−4.

“monoRL-CXCY” means mono-rhamnolipids of the structural formulae (III) and (IV) in which one of the radicals R^{1RL} and R^{2RL}=—(CH₂)ₒ—CH₃ where o=X−4 and the other of the radicals R^{1RL} and R^{2RL}=—(CH₂)ₒ—CH₃ where o=Y−4.

This nomenclature therefore does not distinguish between “CXCY” and “CYCX”.

For rhamnolipids with mRL=0, the terms “monoRL-CX” or “diRL-CX” are used accordingly. If one of the indices X and/or Y is supplemented with “:Z”, this means that the respective radical R^{1RL} or R^{2RL} is an unbranched, unsubstituted hydrocarbon radical having X−3 or Y−3 carbon atoms and Z double bonds.

In cases where the compounds of the structural formulae (III) and (IV) have more than one radical R^{2RL}, the radicals R^{2RL} may be identical or different.

### 1.1.2.3 Sophorolipids

Sophorolipids are in particular compounds of the following structural formula (V), (VII), and salts thereof, preferably compounds of the following structural formula (VI), (VIII), and salts thereof.

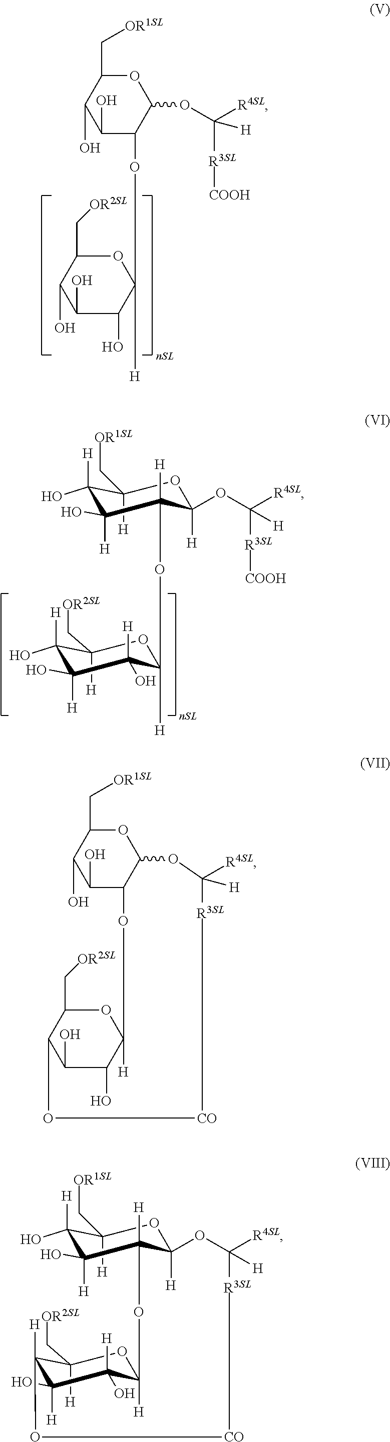

Compounds of the structural formulae (V) and (VI) represent the acid form, and compounds of the structural formulae (VII) and (VIII) represent the lactone form.

In the structural formulae (V), (VI), (IX) and (X), nSL=1 or 0, preferably 1.

In the structural formulae (V), (VI), (VII) and (VIII) [and also for the radicals R^{1SL}, R^{2SL} and R^{4SL} in the structural formulae (IX), (X), (XI) and (XII)], the following applies:
R^{1SL}=H or —CO—CH₃,
R^{2SL}=H or —CO—CH₃,
R^{3SL}=a divalent organic radical having 6 to 32 carbon atoms, preferably 12 to 20, more preferably 14 to 16, most preferably 15, carbon atoms.

R^{3SL} is preferably an optionally substituted divalent hydrocarbon radical having 6 to 32 carbon atoms, with substitution with at least one, in particular exactly one, hydroxy radical being the preferred substitution.

R^{3SL} is more preferably selected from the group consisting of
i. optionally substituted alkylene radicals having 6 to 32, preferably 12 to 20, more preferably 14 to 16, most preferably 15, carbon atoms, with substitution with at least one, in particular exactly one, hydroxy radical being the preferred substitution, and with the carbon chain in the alkylene radical preferably being unbranched;
ii. optionally substituted alkenylene radicals having 6 to 32, preferably 12 to 20, more preferably 14 to 16, most preferably 15, carbon atoms, with substitution with at least one, in particular exactly one, hydroxy radical being the preferred substitution, and with the carbon chain in the alkenylene radical preferably being unbranched, and with the alkenylene radical preferably having 1 to 3, more preferably one, double bond.

R^{3SL} is more preferably still selected from the group consisting of
i. unbranched or branched, preferably unbranched, alkylene radicals having 6 to 32, preferably 12 to 20, more preferably 14 to 16, most preferably 15, carbon atoms;
ii. unbranched or branched, preferably unbranched, alkylene radicals having 6 to 32, preferably 12 to 20, more preferably 14 to 16, most preferably 15, carbon atoms, with in each case the alkylene radical having at least one OH group, preferably one OH group;
iii. unbranched or branched, preferably unbranched, alkenylene radicals having 6 to 32, preferably 12 to 20, more preferably 14 to 16, most preferably 15, carbon atoms, with the alkenylene radical in each case preferably having one to three, more preferably still one, double bond;
iv. unbranched or branched, preferably unbranched, alkenylene radicals having 6 to 32, preferably 12 to 20, more preferably 14 to 16, most preferably 15, carbon atoms, with the alkenylene radical in each case preferably having one to three, more preferably still one, double bond, with in each case the alkenylene radical having at least one OH group, preferably one OH group, and with the alkenylene radical preferably having one to three, more preferably still one, double bond.

R^{4SL}=H, CH₃ or a monovalent organic radical having 2 to 10 carbon atoms.

R^{4SL} is preferably selected from the group consisting of
H,
CH₃,
optionally substituted alkyl radical having 2 to 10 carbon atoms, which is preferably unbranched, with substitution with at least one, in particular exactly one, hydroxy radical being the preferred substitution,
optionally substituted alkenyl radical having 2 to 10 carbon atoms, which is preferably unbranched, with substitution with at least one, in particular exactly one, hydroxy radical being the preferred substitution, with it being preferable for the optionally substituted alkenyl radical to have one to three, preferably one, double or triple bond(s), preferably double bond(s).

R^{4SL} is more preferably still selected from the group consisting of
H,
CH₃,
an unbranched or branched, preferably unbranched, alkyl radical having 2 to 10 carbon atoms,
unbranched or branched, preferably unbranched, alkyl radical having 2 to 10 carbon atoms, which has at least one, preferably one, hydroxy group,
unbranched or branched, preferably unbranched, alkenyl radical having 2 to 10 carbon atoms, with the alkenyl radical having one to three, preferably one, double or triple bond(s), preferably double bond(s),
unbranched or branched, preferably unbranched, alkenyl radical having 2 to 10 carbon atoms, with the alkenyl radical having one to three, preferably one, double or triple bond(s), preferably double bond(s), and with the alkenyl radical having at least one, preferably one, hydroxy group.

R^{4SL} is most preferably selected from the group consisting of H, methyl and ethyl.

Sophorolipids are more preferably still compounds of the following structural formula (IX), (XI), and salts thereof, preferably compounds of the following structural formula (X), (XII), and salts thereof:

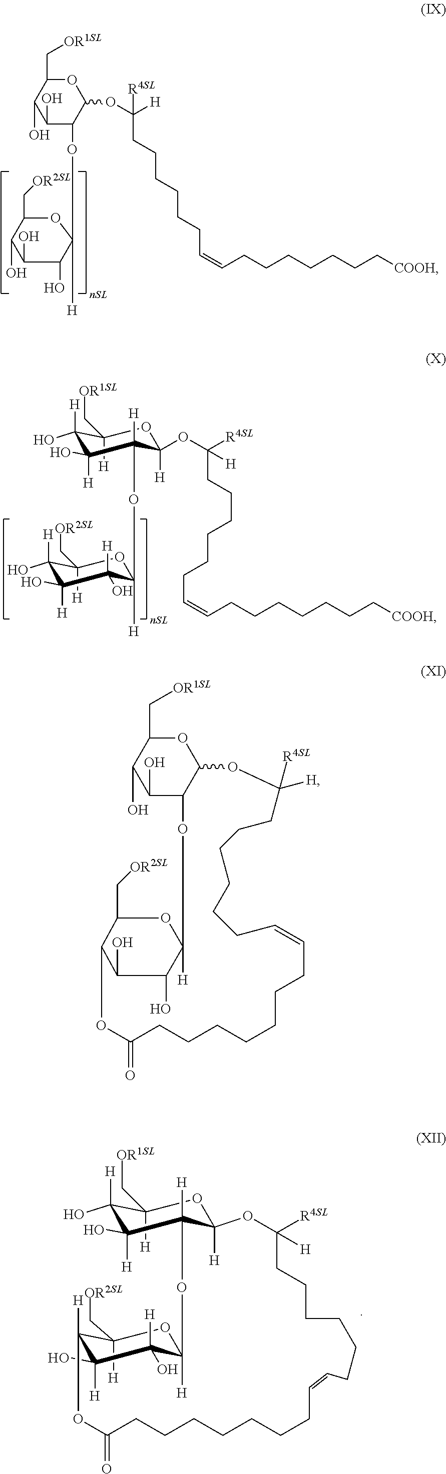

Compounds of the structural formulae (IX) and (X) represent the acid form, and compounds of the structural formulae (XI) and (XII) represent the lactone form.

nSL, R^{1SL}, R^{2SL}, R^{4SL} are defined as has been described for the structural formulae (V), (VII), (VI) and (VIII).

Sophorolipids can be used as mixtures of the acid and lactone form; for example, the ratio of the weight of the sophorolipid in lactone form used to the weight of the sophorolipid in acid form used can lie in the range from 20:80 to 80:20, preferably in the range from 30:70 to 40:60.

The ratio between acid form and lactone form can be determined as per EP 1 411 111 B1, page 8, paragraph [0053].

Sophorolipids can be obtained as described in EP 1 411 111 A1, paragraphs [0021] and [0022].

As sophorolipids, derivatives of the sophorolipids, in particular the derivatives described in EP 4 317 448 A1 or EP 3 034 613 A1, can also be used.

### 1.1.3 Salts

The liquid cleaning composition R preferably comprises salts. These salts may have organic or inorganic cations, in particular cations selected from alkali metal cations or alkaline earth metal cations, preferably from cations selected from the group consisting of Li⁺, Na⁺, K⁺, Cs⁺, Ca²⁺, Mg²⁺. The anions of these salts are in particular selected from the group consisting of halide ions, preferably Cl⁻, or ammonium ions, preferably amides, trialkylammonium ions, in particular triethylammonium ions. A preferred salt is sodium chloride (NaCl).

In a preferred embodiment, the total content of all salts in the liquid cleaning composition R lies in the range from 0.01% by weight to 5% by weight, preferably in the range from 0.5% by weight to 2% by weight, based in each case on the total weight of the liquid cleaning composition R.

The salt is particularly preferably selected from NaCl, MgSO₄, more preferably still NaCl.

### 1.1.4 Surfactant T*

The at least one surfactant T* is a constituent of the surfactant combination T_{Comb}, and is at least one surfactant T* different from G. The surfactant T* is selected from the group consisting of nonionic and anionic surfactants and is preferably a nonionic surfactant, more preferably still an alcohol ethoxylate, yet more preferably still a C₁₀ to C₁₈ alcohol ethoxylate, comprising 3 to 10 units of ethylene oxide per molecule. Yet more preferably still, T* is a C₁₂ to C₁₅ alcohol ethoxylate comprising 5 to 9 units of ethylene oxide per molecule.

“C₁₀ to C₁₈ alcohol ethoxylate preferably comprising on average 3 to 10 units of ethylene oxide per molecule” in particular means mixtures of C₁₀ to C₁₈ alcohol ethoxylates each comprising 3 to 10 units of ethylene oxide per molecule. More preferably still, it means mixtures M_{A} of alcohol ethoxylates containing, based on the total weight of M_{A}, at least 50% by weight, preferably at least 60% by weight, more preferably still at least 70% by weight, more preferably still at least 80% by weight, more preferably still at least 90% by weight, more preferably still at least 99% by weight, most preferably essentially 100% by weight, of C₁₀ to C₁₈ alcohol ethoxylates having 3 to 10 units of ethylene oxide per molecule. In embodiments in which the proportion of C₁₀ to C₁₈ alcohol ethoxylates each having 3 to 10 units of ethylene oxide per molecule in M_{A} is <100% by weight, M_{A} may contain C₁₀ to C₁₈ alcohol ethoxylates each comprising <3 or >10 units of ethylene oxide per molecule. The average of all ethylene oxide units in the C₁₀ to C₁₉ alcohol ethoxylates that M_{A} comprises is then in particular 3 to 10 units, based on all of the C₁₀ to C₁₈ alcohol ethoxylates that the mixture M_{A} comprises.

“C₁₂ to C₁₅ alcohol ethoxylate preferably comprising on average 5 to 9 units of ethylene oxide per molecule” in particular means mixtures of C₁₂ to C₁₅ alcohol ethoxylates each comprising 5 to 9 units of ethylene oxide per molecule. More preferably still, it means mixtures M_{A} of alcohol ethoxylates containing, based on the total weight of M_{A}, at least 50% by weight, preferably at least 60% by weight, more preferably still at least 70% by weight, more preferably still at least 80% by weight, more preferably still at least 90% by weight, more preferably still at least 99% by weight, most preferably essentially 100% by weight, of C₁₂ to C₁₅ alcohol ethoxylates having 5 to 9 units of ethylene oxide per molecule. In embodiments in which the proportion of C₁₂ to C₁₅ alcohol ethoxylates each having 5 to 9 units of ethylene oxide per molecule in M_{A} is <100% by weight, M_{A} may contain C₁₂ to C₁₅ alcohol ethoxylates each comprising <5 or >9 units of ethylene oxide per molecule. The average of all ethylene oxide units in the C₁₂ to C₁₅ alcohol ethoxylates that M_{A} comprises is then in particular 5 to 9 units, based on all of the C₁₂ to C₁₅ alcohol ethoxylates that the mixture M_{A} comprises.

It will be apparent that the surfactant T* is different from the glucolipid G. In particular, the surfactant T* is a synthetic surfactant. “Synthetic” means that no biotechnological process was used in the preparation, i.e. that T* is not produced by microorganisms, in particular not by bacteria or fungi.

The surfactant T* is selected from the group consisting of anionic surfactants and nonionic surfactants and most preferably an anionic surfactant.

### 1.1.4.1 Nonionic Surfactant

Nonionic surfactants that can preferably be used as surfactant T* are alkoxylated, advantageously ethoxylated, alcohols, which are in particular primary alcohols, having preferably 8 to 18 carbon atoms and preferably on average 1 to 12 mol of ethylene oxide (“EO”) per mole of alcohol, wherein the alcohol radical can be linear or branched, and preferably methyl-branched at the 2 position, or can contain a mixture of linear and methyl-branched radicals. Of particular preference, however, are alcohol ethoxylates having linear radicals from alcohols of native origin having 12 to 18 carbon atoms, for example from coconut, palm, tallow fatty or oleyl alcohol, and on average 2 to 8 EO per mole of alcohol. The preferred ethoxylated alcohols include, for example, C₁₂-C₁₄ alcohols having 3 EO, 4 EO or 7 EO, C₉-C₁₁ alcohols having 7 EO, C₁₃-C₁₅ alcohols having 3 EO, 5 EO, 7 EO or 8 EO, C₁₂-C₁₈ alcohols having 3 EO, 5 EO or 7 EO, and mixtures thereof, such as mixtures of C₁₂-C₁₄ alcohols having 3 EO and C₁₂-C₁₈ alcohols having 7 EO. The degrees of ethoxylation indicated are statistical averages that for a given product can be an integer or fraction. Preferred alcohol ethoxylates have a narrow homologous distribution.

In addition to these nonionic surfactants, it is also possible to use fatty alcohols having more than 12 EO. Examples thereof are tallow fatty alcohols having 14 EO, 25 EO, 30 EO or 40 EO. Nonionic surfactants containing EO and propylene oxide (“PO”) groups together in the molecule may also be used. In this context, it is possible to use block copolymers having EO-PO block units or PO-EO block units, but also EO-PO-EO copolymers or PO-EO-PO copolymers. It will of course also be possible to use mixed alkoxylated nonionic surfactants in which EO and PO units are not distributed blockwise but instead randomly. Such products are obtainable through the simultaneous action of ethylene oxide and propylene oxide on fatty alcohols.

In addition, alkyl glycosides may also be used as further nonionic surfactants.

A further class of preferably used nonionic surfactants, which are used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain, in particular fatty acid methyl esters, as are described, for example, in JP S58-217598 or which are prepared preferably by the process described in WO 90/13533 A1.

Nonionic surfactants of the fatty acid alkanolamide type may also be suitable. The amount of these nonionic surfactants is preferably not greater than that of the ethoxylated fatty alcohols, especially not more than half thereof.

Further suitable nonionic surfactants are polyhydroxy fatty acid amides. Polyhydroxy fatty acid amides are substances which can usually be obtained by reductive amination of a reducing sugar with ammonia, an alkylamine or an alkanolamine and subsequent acylation with a fatty acid, a fatty acid alkyl ester or a fatty acid chloride.

Nonionic surfactants that can be used more preferably still as T* are alcohol ethoxylates (“AEs” or “AEOs”), alcohol propoxylates, propoxylated fatty alcohols (“PFAs”), alkoxylated fatty acid alkyl esters such as ethoxylated and/or propoxylated fatty acid alkyl esters, alkylphenol ethoxylates (“APEs”), nonylphenol ethoxylates (“NPEs”), alkyl polyglycosides (“APGs”), alkoxylated amines, fatty acid monoethanolamides (“FAMs”), fatty acid diethanolamides (“FADAs”), ethoxylated fatty acid monoethanolamides (“EFAMs”), polyglycerol esters, glycerol esters, propoxylated fatty acid monoethanolamides (“PFAMs”), polyhydroxyalkyl fatty acid amides or N-acyl-N-alkyl derivatives of glucosamine (glucamides, “GAs” or fatty acid glucamides, “FAGAs”), and products available under the trade names “SPAN” and “TWEEN”, and combinations thereof.

Nonionic surfactants that can be used yet more preferably still as T* are selected from the group consisting of AEs, alcohol propoxylates, PFAs, alkoxylated fatty acid alkyl esters, APEs, NPEs, APGs, alkoxylated amines, FAMs, FADAs, EFAMs.

Nonionic surfactants that can be used yet more preferably still as T* are selected from the group consisting of AEs, alcohol propoxylates, PFAs, alkoxylated fatty acid alkyl esters.

### 1.1.4.2 Anionic Surfactant

Examples of anionic surfactants that can be used preferably as surfactant T* include those anionic surfactants mentioned in WO 2014/173659 A1, page 3, lines 15 to 25 and those anionic surfactants mentioned on page 3, line 18 to page 4, line 22 of WO 2014/118095 A1 and those mentioned in WO 2019/219303 A1, page 5, line 1 to page 6, line 6.

It is preferable for the anionic surfactants to be of the sulfonate and sulfate type.

Suitable anionic surfactants of the sulfonate type are here preferably C₉-C₁₃ alkylbenzenesulfonates, olefinsulfonates, i.e. mixtures of alkene- and hydroxyalkanesulfonates, and also disulfonates, as are obtained for example from C₁₂-C₁₈ monoolefins having a terminal or internal double bond by sulfonation with gaseous sulfur trioxide followed by alkaline or acidic hydrolysis of the sulfonation products. Also suitable are alkanesulfonates obtained from C₁₂-C₁₈ alkanes, for example by sulfochlorination or sulfate oxidation followed by hydrolysis or neutralization. Similarly suitable are also the esters of the α-sulfo fatty acids (ester sulfonates), for example the α-sulfonated methyl esters of hydrogenated coconut, palm kernel or tallow fatty acids.

Further suitable anionic surfactants are sulfated fatty acid glycerol esters. Fatty acid glycerol esters are to be understood as meaning the mono-, di- and triesters, and mixtures thereof, as are obtained during the preparation by esterification of a monoglycerol with 1 to 3 mol of fatty acid or during the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alkyl sulfates and alkenyl sulfates are the alkali metal salts and in particular the sodium salts of the sulfuric monoesters of C₁₂-C₁₈ fatty alcohols, for example from coconut fatty alcohol, tallow fatty alcohol, lauryl, myristyl, cetyl or stearyl alcohol or C₁₀-C₂₀ oxo alcohols (oxo alcohols are alcohols produced by catalytic hydrogenation of aldehydes from the hydroformylation reaction of olefins with synthesis gas) and such monoesters of secondary alcohols of these chain lengths. Furthermore, preference is given to using alkyl sulfates and alkenyl sulfates of the indicated chain length which contain a synthetic straight-chain alkyl radical that has been produced on a petrochemical basis and which have an analogous degradation behaviour to the suitable compounds based on fatty chemical raw materials. From the viewpoint of washing, preference is given to C₁₂-C₁₆ alkyl sulfates and C₁₂-C₁₈ alkyl sulfates and also C₁₄-C₁₈ alkyl sulfates. 2,3-alkyl sulfates, which are prepared for example according to U.S. Pat. No. 3,234,258 A or U.S. Pat. No. 5,075,041 A and can be obtained as commercial products from the Shell Oil Company under the name DAN®, are also suitable anionic surfactants.

Also suitable are the sulfuric monoesters of straight-chain or branched C₇-C₂₀ alcohols ethoxylated with 1 to 6 mol of ethylene oxide (“EO”), such as for example 2-methyl-branched C₉-C₁₁ alcohols having on average 3.5 mol of EO or C₁₂-C₁₈ fatty alcohols having 1 to 4 EO. Due to their strong foaming behaviour, they are used in cleaning compositions only in relatively small amounts, for example in amounts of 1% to 5% by weight.

Further suitable anionic surfactants are also the salts of alkylsulfosuccinic acid, which are also referred to as sulfosuccinates or sulfosuccinic esters and constitute the monoesters and/or diesters of sulfosuccinic acid with alcohols, preferably fatty alcohols and in particular ethoxylated fatty alcohols. Preferred sulfosuccinates contain C₈-C₁₈ fatty alcohol radicals or mixtures thereof. Particularly preferred sulfosuccinates contain a fatty alcohol radical derived from ethoxylated fatty alcohols. Particular preference is given in this context in turn to sulfosuccinates the fatty alcohol radicals of which are derived from ethoxylated fatty alcohols having a narrow homologous distribution. It is also possible to use alkylsuccinic acid and alkenylsuccinic acid with preferably 8 to 18 carbon atoms in the alkyl chain/alkenyl chain, or salts thereof.

Particularly preferred anionic surfactants are soaps. Also suitable are saturated and unsaturated fatty acid soaps, such as the salts of lauric acid, myristic acid, palmitic acid, stearic acid, (hydrogenated) erucic acid and behenic acid, and also soap mixtures obtained in particular from natural fatty acids, for example coconut, palm kernel, olive oil or tallow fatty acids.

The anionic surfactants including the soaps can be present in the form of their sodium, potassium or ammonium salts and also soluble salts of organic bases, such as mono-, di- or triethanolamine.

Preferably, the anionic surfactants are present in the form of their sodium or potassium salts, in particular in the form of the sodium salts.

Anionic surfactants that can be used more preferably still as T* are sulfates and sulfonates, in particular selected from the group consisting of linear alkylbenzenesulfonates (“LASs”), isomers of LASs, branched alkylbenzenesulfonates (“BABSs”), phenylalkanesulfonates, α-olefinsulfonates (“AOSs”), olefinsulfonates, alkenesulfonates, alkyl-2,3-diyl bis(sulfates), hydroxyalkylsulfonates, hydroxyalkyldisulfonates, alkyl sulfates (“ASs”) such as sodium dodecyl sulfate (“SDS”), fatty alcohol sulfates (“FASs”), sulfates of primary alcohols (“PASs”), alcohol ether sulfates (“AESs” or “AEOSs” or “FESs”, such as for example alcohol ethoxysulfates or fatty acid ether sulfates) such as for example sodium dodecyl poly(oxyethylene) sulfate (“SLES”), secondary alkyl sulfonates (“SASs”), paraffinsulfonates (“PSs”), ester sulfonates, sulfonated fatty acid glycerol esters, α-sulfo fatty acid methyl esters (“α-SFMe” or “SESs”) such as for example methyl ester sulfonate (“MES”), alkyl- or alkenylsuccinic acid, dodecenyl/tetradecenylsuccinic acid (“DTSA”), fatty acid derivatives of amino acids, diesters and monoesters of sulfosuccinic acids or soaps.

Anionic surfactants that can be used yet more preferably still as T* are selected from the group consisting of LASs, alcohol ether sulfates, in particular SLES and LASs.

### 1.1.4.3 Cationic Surfactant

The liquid cleaning composition R may also comprise at least one cationic surfactant. Preferred cationic surfactants that can be used as surfactant are selected from the group consisting of alkyldimethylethanolamine quat (“ADMEAQ”), cetyltrimethylammonium bromide (“CTAB”), dimethyldistearylammonium chloride (“DSDMAC”) and alkylbenzyldimethylammonium, alkyl quaternary ammonium compounds, alkoxylated quaternary ammonium compounds (“AQA”), and combinations thereof.

### 1.1.5 Active Ingredient Capsules W_{K}

The liquid cleaning composition R optionally also comprises active ingredient capsules W_{K} comprising at least one active ingredient B.

The active ingredient capsules W_{K} are in particular macroscopic or microscopic, preferably macroscopic. “Macroscopic” means in particular that the diameter of the active ingredient capsules W_{K} is ≥3 μm, and preferably lies in the range from 3 μm to 10 μm. “Microscopic” means in particular that the diameter of the active ingredient capsules W_{K} is <3 μm, and preferably lies in the range from 0.01 μm to <3 μm, more preferably still in the range from 0.1 μm to 2 μm.

In a further embodiment of the present invention, the particle size and average diameter of the active ingredient capsules W_{K} lie in the range from 10 nm to 1000 μm, preferably in the range from 50 nm to 100 μm, more preferably in the range from 2 μm to 40 μm, more preferably still in the range from 4 μm to 15 μm, yet more preferably still in the range from 5 μm to 10 μm, more preferably still in the range from 6 μm to 7 μm.

The statistical distribution of the particle size and the average diameter of the active ingredient capsules W_{K} can be narrow, broad or multimodal. Multimodal distributions may be present when active ingredient capsules W_{K} of various capsule chemistry types are used.

In a preferred embodiment, the active ingredient capsules W_{K} comprise a shell S enveloping a core K, wherein preferably at least one active ingredient B is located in the core K.

The active ingredient capsules W_{K}, in particular the shell S of the active ingredient capsules W_{K}, preferably comprise urea-formaldehyde and/or melamine-formaldehyde.

In one embodiment, the active ingredient capsules W_{K} may comprise microcapsules, i.e. the active ingredient B is then present as microcapsules. “Microcapsules” means in particular that the diameter of the active ingredient B is <3 μm, and preferably lies in the range from 0.01 μm to <3 μm, more preferably still in the range from 0.1 μm to 2 μm.

In a preferred embodiment, the active ingredient capsules W_{K} are those which release the at least one active ingredient B by the action of pressure and/or shear forces, in particular friction, pressure and/or shear stress, on the active ingredient capsules W_{K}. This is preferred for fragrance active ingredients, where these fragrance active ingredients in the active ingredient capsules W_{K} are released by mechanical action (e.g. friction, pressure, shear forces).

In addition to or as an alternative to this mechanism of release, those active ingredient capsules W_{K} can also be used which release the at least one active ingredient B by B diffusing out from the outermost shell of the active ingredient capsule W_{K}. The sensorially beneficial active ingredient contained therein is released by diffusion through the outer wall of the capsule.

Preferred active ingredient capsules W_{K} within the context of the present invention are active ingredient capsules W_{K} that release the active ingredient B as a result of friction. These active ingredient capsules W_{K} more preferably still comprise melamine-formaldehyde. Corresponding commercially available active ingredient capsules W_{K} are for example available under the trade names “Aroma Ball Type 1” and “Aroma Ball S-series encapsulates” (from Polychrome, South Korea).

In a preferred embodiment, the active ingredient capsules W_{K} comprise a shell S enveloping a core K. This shell S preferably comprises at least one substance selected from the group consisting of polyurethanes, polyamide, polyolefin, polysaccharide, protein, silicone, lipid, cellulose, modified cellulose, rubber resin, polyacrylate, polyphosphate, polystyrene, polyester, polymethyl methacrylate. The shell S more preferably still comprises at least one substance selected from the group consisting of melamine-formaldehyde condensates and urea-formaldehyde condensates. The shell S may also comprise similar types of aminoplasts. The shell S most preferably comprises melamine-formaldehyde condensate.

Active ingredient capsules W_{K} obtained by coacervation of gelatine can also be used.

The terms “melamine-formaldehyde condensation resin”, “melamine-formaldehyde” and “melamine resin” are used synonymously within the context of this invention.

The terms “urea-formaldehyde condensation resin”, “urea-formaldehyde” and “urea resin” are used synonymously within the context of this invention.

The coacervation of gelatine is particularly preferred for obtaining microcapsules, which are used in the process according to the invention as active ingredient capsules W_{K} or as active ingredient B.

The production of capsules comprising aminoplasts (which can then be used as active ingredient capsules W_{K} or active ingredients B) is known to those skilled in the art and described, for example, in U.S. Pat. No. 3,516,941 A. A typical process for producing capsules comprising gelatine, which can then be used as active ingredient capsules W_{K} or active ingredients B, is known to those skilled in the art and described, for example, in U.S. Pat. No. 2,800,457 A. The encapsulation of odorants for the use of the obtained active ingredient capsules in consumer articles is described in U.S. Pat. Nos. 4,145,184 A and 5,112,688 A. Depending on the technique used, pore gaps or interstitial openings can arise as a result of the encapsulation.

Fragrance capsules known in the art and suitable for use in the present invention as active ingredient capsules W_{K} comprise a wall or shell S, preferably a shell S comprising, and in particular consisting of, a three-dimensionally crosslinked network of an aminoplast resin, preferably comprising, and particularly preferably consisting of, a substituted or unsubstituted acrylic acid polymer or copolymer crosslinked with a urea-formaldehyde precondensate or a melamine-formaldehyde precondensate.

The formation of microcapsules using mechanisms similar to the above mechanism using (i) melamine-formaldehyde or urea-formaldehyde precondensates and (ii) polymers containing substituted vinyl monomer units with associated proton-releasing functional group contents (e.g. sulfonic acid groups or carboxylic anhydride groups) is disclosed in U.S. Pat. No. 4,406,816 A (2-acrylamido-2-methylpropanesulfonic acid groups), GB 2,062,570 A (styrenesulfonic acid groups) and GB 2,006,709 A (carboxylic anhydride groups).

In one particular embodiment of the present invention, the active ingredient capsules W_{K} also comprise a carrier oil, preferably in the core.

The carrier oils are hydrophobic materials which are miscible with the active ingredients B used in the present invention, in particular with volatile active ingredients B.

Suitable oils are those which have an appropriate affinity for the active ingredient B. If the active ingredient B is a perfume, materials suitable for use as carrier oil, without being limited thereto, comprise in particular at least one oil selected from the group consisting of triglyceride oil, mono- and diglycerides, mineral oil, silicone oil, diethyl phthalate, polyalphaolefins, castor oil and isopropyl myristate.

Preferably, the oil is a triglyceride oil, particularly preferably a caprylic/capric triglyceride oil.

### 1.1.6 Deposition Aids A_{D}

The active ingredient capsule W_{K}, in particular the shell S of the active ingredient capsule W_{K}, may further comprise a deposition aid A_{D}, which is preferably covalently bonded.

The deposition aid A_{D} is preferably a polysaccharide which preferably has a β-1,4-linked backbone. Preferably, the polysaccharide is at least one selected from cellulose, cellulose derivative, or the polysaccharide is another β-1,4-linked polysaccharide having an affinity for cellulose, such as polymannan, polyglucan, polyglucomannan, polyxyloglucan, and polygalactomannan, or a mixture thereof. The polysaccharide may also be selected from the group consisting of polyxyloglucan (also referred to as “xyloglucan”) and polygalactomannan (also referred to as “galactomannan”).

Preferred polymannans are acetylated polymannan polysaccharides.

Polysaccharides preferred especially as a deposition aid A_{D} are selected from carob seed flour, tamarind seed flour, xyloglucan, nonionic guar flour, cationic starch, and mixtures thereof. As deposition aid A_{D}, carob seed flour is most preferred.

Preferably, the backbone of the polysaccharide used as a deposition aid A_{D} has only β-1,4 bonds. Optionally, the polysaccharide used as deposition aid A_{D} has additional linkages to the β-1,4 linkages, for example, β-1,3 linkages. Therefore, yet further linkages are optionally present. As deposition aid A_{D}, it is also possible to use polysaccharides having polysaccharide basic skeletons containing (whether terminally or within the polysaccharide chain) a material or a chemical structure that is not a saccharide ring.

The polysaccharide used as a deposition aid A_{D} can be linear or branched.

Many naturally occurring polysaccharides have at least a certain degree of branching, or at least some saccharide rings are present in the form of pendent side groups on a polysaccharide main backbone (which are preferably not taken into account when determining the degree of substitution).

Preferably, the polysaccharide used as a deposition aid A_{D} is present in a proportion in the range from 0.1% by weight to 10% by weight, based on the total weight of the active ingredient capsules W_{K}.

The deposition aid A_{D}, which is preferably a polysaccharide, is bonded to the particles, in particular the active ingredient capsules W_{K}, in particular via a covalent bond, by entanglement or by adsorption, preferably via a covalent bond or entanglement and particularly preferably via a covalent bond. “Entanglement” is to be understood here as meaning that the deposition aid A_{D} is adsorbed on the particle, in particular the active ingredient capsule W_{K}, in the course of the polymerization and as the particle size increases, with a portion of the adsorbed deposition aid A_{D} being buried within the particle, in particular the active ingredient capsule W_{K}. Therefore, at the end of the polymerization, a portion of the deposition aid A_{D} is embedded and bound within the polymer matrix of the particle, in particular the active ingredient capsule W_{K}, while the rest protrudes unhindered and, when the particle, in particular the active ingredient capsule W_{K}, is present in the liquid cleaning composition R, contacts the liquid cleaning composition R/can extend into the latter.

Adsorption is understood here in particular to mean adsorption of the deposition aid A_{D} on the surface of the particle, in particular the active ingredient capsule W_{K}; such adsorption can for example be achieved on the basis of hydrogen bonds, van der Waals bonding or electrostatic attraction between the deposition aid A_{D} and the particle, in particular the active ingredient capsule W_{K}. In this embodiment, the deposition aid A_{D} therefore adheres mainly to the surface of the particle, in particular the active ingredient capsule W_{K}, and is not distributed to a significant extent in the interior of the particle, in particular the active ingredient capsule W_{K}. This differs from graft copolymers, in which, for example, a polysaccharide can be grafted along the length of a polymer chain.

A particle, in particular an active ingredient capsule W_{K}, which has been formed from a graft copolymer would therefore contain polysaccharides throughout the interior of the particle as well as on the particle surface. These kinds of particles can be used within the context of the present invention, but are less preferred as active ingredient capsule W_{K}. Thus, the particle which is obtained as active ingredient capsule W_{K} when using a polysaccharide as deposition aid A_{D} according to the process of the invention can be imagined as a “hairy particle” which differs from a graft copolymer. This feature of the invention offers the manufacturer considerable possibilities for reducing costs, since much less deposit aid is required to achieve the same level of activity as in systems that use polysaccharide copolymers.

In a preferred embodiment, the deposition aid A_{D} is located in the outermost part of the shell S of the active ingredient capsule W_{K}, the shell S comprising melamine-formaldehyde polymer and/or urea-formaldehyde polymer, preferably melamine-formaldehyde polymer, with the shell S more preferably still consisting of melamine-formaldehyde polymer and/or of urea-formaldehyde polymer, more preferably still consisting of melamine-formaldehyde polymer. The shell S in particular has a thickness in the range from 5 nm to 20 nm.

As deposition aid A_{D}, it is also possible to use polymers such as the polymers P_{C} described below.

### 1.1.7 Polymer P_{C}

The liquid cleaning composition R comprises at least one polymer P_{C}, where P_{C} is selected from the group consisting of alkoxylated polyamine and polyester soil release polymer, wherein the proportion of all polymers P_{C} lies preferably in the range from 0.1% by weight to 15% by weight, preferably 0.1% by weight to 10% by weight, based in each case on the total weight of the liquid cleaning composition R.

### 1.1.7.1 Polyester Soil Release Polymers

In the embodiments of the present invention in which the liquid cleaning composition R comprises at least one polymer P_{C}, where P_{C} is selected from the group of polyester soil release polymers, the proportion of all polyester soil release polymers is preferably in the range from 0.1% by weight to 15% by weight, preferably 0.1% by weight to 10% by weight, more preferably still 0.1% by weight to 5% by weight, based in each case on the total weight of the liquid cleaning composition R.

Possible polyester soil release polymers which can be used within the context of the invention are described in WO 2019/219531 A1, WO 2014/029479 A1, WO 2016/005338 A1.

Polyester soil release polymers are preferably selected from polyesters of terephthalic acid and other aromatic dicarboxylic acids with dirt-removing properties.

As “polyester soil release polymers”, preference is additionally in particular given to so-called PEG/POET (polyethylene glycol/polyoxyethylene terephthalate) polyester, PET/POET (polyethylene terephthalate/polyoxyethylene terephthalate) and PET/PEG (polyethylene terephthalate/polyethylene glycol) polyester. Particular preference among these is given to PET/POET.

In a further preferred embodiment, the polymer P_{C} has at least one mole of free OH groups per mole of polymer in order to enable a covalent bond to, in particular, reactive dye(s) used. Particularly preferably, the polymer P_{C} has at least two free OH groups. Preferably, the OH groups are the end groups of the polymer P_{C}.

The polymer P_{C} may also comprise groups selected from oxyalkyleneoxy group [—O(CH₂)ₜO—] or polyoxyalkyleneoxy group [—O(CH₂)_{w}—]ₛO—, where t, w and s are independently integers.

Preferably, the oxyalkyleneoxy group is selected from the following groups: oxy-1,3-propyleneoxy [O—CH₂CH₂CH₂O—], oxy-1,2-ethyleneoxy [—OCH₂CH₂O—]. In this case, one or more of the CH₂ groups of the oxyalkyleneoxy may be substituted by C₁- to C₄ alkyl groups, meaning that oxy-1,2-propyleneoxy {—OCH₂[CH(CH₃)]O—} is also possible as preferred oxyalkyleneoxy group.

A polyoxyalkyleneoxy group facilitates the water solubility of the polymer P_{C}.

Preferably, the polyoxyalkyleneoxy group is selected from:
polyoxy-1,2-propyleneoxy {—O(CH₂[CH(CH₃)]—}ₛO—;
polyoxy-1,3-propyleneoxy [O—CH₂CH₂CH₂—]ₛO—; and
polyoxy-1,2-ethyleneoxy [O—CH₂CH₂—]ₛO—.

The polyoxyalkyleneoxy group can be a mixture of various oxyalkyleneoxy groups.

Accordingly, various polyoxyalkyleneoxy types may be present in the polymer P_{C}.

The polymer P_{C} may also comprise a 1,4-phenyldicarboxylate group. This preferably has the structure —OC(═O)-phenyl ring-C(═O)—O—. The two carboxylate groups are in para position to one another on the phenyl ring.

The polyester soil release polymer, as polymer P_{C}, preferably has a structure of the chemical formula (I)*:

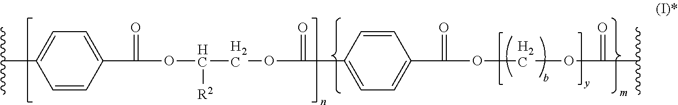

The following applies in the chemical formula (I)*:
R² is selected from CH₃ and H, preferably R²=H.
b=2 or 3, preferably b=3.
y=an integer in the range from 2 to 100, preferably an integer in the range from 5 to 50.
n and m are each independently an integer in the range from 1 to 100, preferably each an integer in the range from 2 to 30.

The units parenthesized with “n” and “m” may appear in alternating fashion or in blocks in the polymer P_{C} of chemical structure (I)*. The terminal (end) groups of the polymer P_{C} of chemical structure (I)* are —(CH₂)_{b}OH.

Another preferred structure for the polymer P_{C}, in embodiments in which it is a polyester soil release polymer, is the one of chemical structure (II)*:

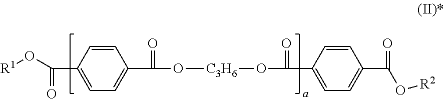

In the chemical formula (II)*:
R¹ and R² are each independently selected from (i), (ii), (iii), (iv), where (i) is preferred,
   (i) X—(OC₂H₄)ₙ—(OC₃H₆)ₘ—(*), in which X=C₁₋₄ alkyl, preferably X=methyl;
   (ii) X—(OC₃H₆)ₘ—(OC₂H₄)ₙ—(*), in which X=C₁₋₄ alkyl, preferably X=methyl;
   (iii) X—(OC₃H₆)ₘ—(*), in which X=C₁₋₄ alkyl, preferably X=methyl;
   (iv) X—(OC₂H₄)ₙ—(*), in which X=C₁₋₄ alkyl, preferably X=methyl;
wherein the —(OC₂H₄) groups and the (OC₃H₆) groups in the radicals (i) and (ii) are present in blockwise or mixed form (=not blockwise), preferably blockwise form,
wherein “(*)” denotes the bond to the singly bonded oxygen of the respective “COO” group in the structure (II)*,
n=an integer in the range from 12 to 120, preferably 40 to 50,
m=an integer in the range from 1 to 10, preferably 2 to 7,
a=an integer in the range from 4 to 9.

The polymers P_{C}, in particular those of the chemical structure (I)* or (II)**, can be synthesized by various routes, for example by an esterification reaction of dimethyl terephthalate with ethylene glycol and polyethylene glycol. This reaction is described by F. Khorshahi, S. Lin, A. Jensen, D. Kwoh, Polymer Bulletin 1992, 28, 451-458.

Alternatively, the polymers P_{C}, in particular those of the chemical structure (I)*, can be obtained by the direct esterification of terephthalic acid with ethylene glycol and/or propylene glycol and polypropylene glycol or by transesterification of a polyethylene terephthalate with a polyethylene glycol or polypropylene glycol.

It is preferable for the average molecular weight of the polymer P_{C}, in particular the average molecular weight of the polymers P_{C} of the chemical structure (I)* or (II)**, to lie in the range from 1000 g/mol to 50 000 g/mol, preferably in the range from 1000 g/mol to 15 000 g/mol, more preferably from 2000 g/mol to 10 000 g/mol.

The polyester which is used as polymer P_{C} is preferably a mixture M_{P} of
α) at least one of the aforementioned compounds of the chemical structure (II)* [45% by weight to 55% by weight, based on the total weight of M_{P}],
β) at least one alcohol selected from the group consisting of ethylene glycol, 1,2-propylene glycol, 1,3-propylene glycol, 1,2-butylene glycol, 1,3-butylene glycol, 1,4-butylene glycol, butyl glycol [10% by weight to 30% by weight, based on the total weight of M_{P}],
γ) 24% by weight to 42% by weight of water, based on the total weight of M_{P}.

### 1.1.7.2 Alkoxylated Polyamines

In the embodiments of the present invention in which the liquid cleaning composition R comprises at least one polymer P_{C}, where P_{C} is selected from the group of alkoxylated polyamines, the proportion of all alkoxylated polyamines is preferably in the range from 0.1% by weight to 15% by weight, preferably in the range from 0.1% by weight to 10% by weight, more preferably still in the range from 0.25% by weight to 8% by weight, more preferably still in the range from 0.5% by weight to 6% by weight, more preferably still in the range from 1% by weight to 4% by weight, based in each case on the total weight of the liquid cleaning composition R.

A preferred alkoxylated polyamine is selected from alkoxylated polyethyleneimine and alkoxylated polypropyleneimine. The polyamine is branched (and may be a dendrimer) or unbranched. The alkoxylation is, in particular, ethoxylation, propoxylation, or a mixture of the two. In the case of the alkoxylation of a nitrogen, the preferred degree of alkoxylation is in the range from 10 to 30, preferably in the range from 15 to 25. Particular preference is given to an ethoxylated polyethyleneimine, where the average degree of ethoxylation lies in the range from 10 to 30, preferably in the range from 15 to 25.

### 1.1.8 Active Ingredient B

The active ingredient B is not further restricted and can be selected depending on the application of the liquid cleaning composition R.

It is preferably selected from the group consisting of:
perfumes, insect repellents, essential oils,
menthol-containing odorants and aromatherapy active ingredients,
humectants and/or softeners for skin and/or hair, comprising mineral oil, petrolatum, silicone oil, comprising dimethylpolysiloxane, lauryl lactate and myristyl lactate,
antidandruff active ingredients, in particular selected from the group consisting of zinc salts, in particular zinc pyrithione, zinc sulfate and hydrates thereof,
piroctone olamine (CAS number: 68890-66-4), selenium sulfide, azole antimicrobial agents, in particular climbazole,
silicones, in particular selected from the group consisting of polyalkylsiloxanes, polyarylsiloxanes, polyalkylarylsiloxanes, polyethersiloxane copolymer, aminosilicones, silicone rubbers, crosslinked silicone elastomers,
cationic polymers, in particular a cationic guar flour derivative, preferably guar hydroxypropyltrimonium chloride.

Preferably, the active ingredient B that the active ingredient capsule W_{K} comprises is a skin active ingredient or an odour active ingredient and/or a volatile active ingredient.

Sensory active ingredients may also have advantages for hair and/or hard surfaces and/or textiles.

Suitable volatile active ingredients include perfumes, insect repellents, essential oils, fragrances such as menthol and aromatherapy active ingredients, preferably perfumes.

It is possible to use mixtures of volatile active ingredients.

The total amount of the active ingredient B is preferably 0.01% by weight to 10% by weight (in the context of the invention, the percentage by weight is abbreviated as “% by weight”), more preferably 0.05% by weight to 5% by weight, more preferably still 0.1% to 4.0% by weight, most preferably 0.15% to 4.0% by weight, based on the total weight of the active ingredient capsule W_{K}.

As active ingredient B, it is possible according to the invention to use an encapsulated or unencapsulated volatile active ingredient.

If the volatile active ingredient is a perfume, the perfumes described below are suitable for use as encapsulated volatile active ingredient and also as free perfume component.

### 1.1.9 Perfume

A preferred active ingredient B is a perfume PF or a perfume mixture M_{PF}. The constituents of the perfume PF can be selected from materials of natural or synthetic origin.

Such materials may be individual compounds or mixtures. Specific examples of such compounds or mixtures can be found in the literature, for example in
i. George A. Burdock, “Fenaroli's Handbook of Flavor Ingredients”, 6th Edition, 2009, CRC Press;
ii. Morris Boris Jacobs, “Synthetic Food Adjuncts”, 2013, Literary Licensing LLC;
iii. Steffen Arctander, “Perfume and Flavor Chemicals”, 1969, Montclair, N. J. (USA).

These substances are well known to those skilled in the art of perfuming, flavouring and/or aromatizing consumer goods, i.e. they impart an odour and/or an aroma or a taste to conventionally perfumed or aromatized consumer goods, or they modify the odour and/or taste of said consumer goods.

For the purposes of the invention, “perfume” is understood to mean not only the final formulated fragrance of a product, but also selected constituents of that fragrance, in particular those that can easily be lost, such as what are known as the top notes.

“Top notes” are defined by W. A. Poucher, Journal of the Society of Cosmetic Chemists 1955, 6, 80-94. Examples of known top notes are citrus oils, linalool, linalyl acetate, lavender, 2,6-dimethyl-7-octen-2-ol (“dihydromyrcenol”), rose oxide and cis-3-hexanol. Top notes typically comprise 15% to 25% by weight of a perfume composition, based on the total weight of the perfume composition, and, in particular in the embodiments of the invention in which the active ingredient B contains an elevated proportion of top notes, it is provided that the active ingredient B comprises at least 20% by weight of perfume PF, based on the total weight of all of the active ingredients B that the active ingredient capsule W_{K} comprises.

Some or all perfumes PF or the precursors of the perfumes PF may be encapsulated. Typical perfume components, the encapsulation of which is advantageous, comprise those having a relatively low boiling point, preferably those having a boiling point of less than 300° C., preferably 100° C. to 250° C., and precursors to such perfumes.

It is also advantageous to encapsulate perfume components having a low C Log P value (that is to say those that dissolve in water), preferably having a C Log P value of less than 3.0. These substances having relatively low boiling point and relatively low C Log P are termed “delayed bloom” perfume constituents and include the following substances (“List I”): allyl caproate, amyl acetate, amyl propionate, anisaldehyde, anisole, benzaldehyde, benzyl acetate, benzylacetone, benzyl alcohol, benzyl formate, benzyl isovalerate, benzyl propionate, β-7-hexenol, camphor gum, (R)-(−)-carvone (CAS No.: 6485-40-1), (S)-(+)-carvone (CAS No.: 2244-16-8), cinnamyl alcohol, cinnamyl formate, cis-jasmone, cis-3-hexenyl acetate, cumin alcohol, Cyclal C (“2,4-dimethyl-3-cyclohexene-1-carbaldehyde”; CAS No.: 68039-49-6), dimethylbenzylcarbinol, dimethylbenzylcarbinol acetate, ethyl acetate, ethyl acetoacetate, ethyl amyl ketone, ethyl benzoate, ethyl butyrate, ethyl hexyl ketone, ethylphenyl acetate, eucalyptol, eugenol, fenchyl acetate, flor acetate (=tricyclodecenyl acetate; CAS No.: 5413-60-5), frutene (tricyclodecenyl propionate; CAS No.: 17511-60-3), geraniol, hexenol, hexenyl acetate, hexyl acetate, hexyl formate, hydratropic alcohol (=2-phenylpropan-1-ol; CAS No.: 1123-85-9), hydroxycitronellal, indole, isoamyl alcohol, isomenthone, isopulegyl acetate, isoquinolone, Ligustral, linalool, linalool oxide, linalyl formate, menthone, menthylacetophenone, methyl amyl ketone, methyl anthranilate, methyl benzoate, methylbenzyl acetate, methyleugenol, methylheptenone, methyl heptine carbonate, methyl heptyl ketone, methyl hexyl ketone, methylphenylcarbinyl acetate, methyl salicylate, methyl N-methylanthranilate, nerol, octalactone, octyl alcohol, p-cresol, p-cresol methyl ether, p-methoxyacetophenone, p-methylacetophenone, phenoxyethanol, phenylacetaldehyde, phenylethyl acetate, phenylethyl alcohol, phenylethyldimethylcarbinol, prenyl acetate, bornyl acetate, bornyl propionate, pulegone, rose oxide, safrole, terpinen-4-ol, α-terpinenol and/or Viridine.

If unencapsulated or “free” perfume constituents are used, hydrophobic perfume components having a C Log P above 3 are preferable.

As used herein, the term “C Log P” refers to the calculated decadic logarithm of the octanol/water partition coefficient (P).

The octanol/water partition coefficient of a perfume raw material (PRM) is the ratio between its equilibrium concentrations in octanol and water, in particular at 25° C.

Since this measure is a ratio of the equilibrium concentration of a PRM in a non-polar solvent (octanol) to its concentration in a polar solvent (water), C Log P is also a measure of the hydrophobicity of a material—the higher the C Log P value, the more hydrophobic the material. C Log P values can easily be calculated using a program called “C LOG P”, which is available from Daylight Chemical Information Systems Inc., Irvine, California, USA. Octanol/water partition coefficients are described in more detail in U.S. Pat. No. 5,578,563 A.

Perfume constituents with a C Log P>3 include (“List II”): Iso E Super (=at least one tetramethyl acetyloctahydronaphthalene, e.g. at least one selected from the substances having the following CAS Nos.: 54464-57-2; 68155-66-8; 68155-67-9), citronellol, ethyl cinnamate, bangalol, 2,4,6-trimethylbenzaldehyde, hexylcinnamaldehyde, 2,6-dimethyl-2-heptanol, diisobutylcarbinol, ethyl salicylate, phenethyl isobutyrate, ethyl hexyl ketone, propyl amyl ketone, dibutyl ketone, heptyl methyl ketone, 4,5-dihydrotoluene, caprylaldehyde, citral, geranial, isopropyl benzoate, cyclohexanepropionic acid, campholenaldehyde, caprylic acid, capryl alcohol, cuminaldehyde, 1-ethyl-4-nitrobenzene, heptyl formate, 4-isopropylphenol, 2-isopropylphenol, 3-isopropylphenol, allyl disulfide, 4-methyl-1-phenyl-2-pentanone, 2-propylfuran, allyl caproate, styrene, isoeugenyl methyl ether, indonaphthene, diethyl suberate, menthone [as racemic mixture (CAS No.: 89-80-5), but also as pure (2S,5R)-(−)-menthone (“L-menthone”; CAS No.: 14073-97-3), and as pure (2R,5S)-(+)-menthone (“D-menthone”; CAS No.: 3391-87-5)], p-cresyl isobutyrate, butyl butyrate, ethyl hexanoate, propyl valerate, n-pentyl propanoate, hexyl acetate, methyl heptanoate, trans-3,3,5-trimethylcyclohexanol, 3,3,5-trimethylcyclohexanol, ethyl p-anisate, 2-ethyl-1-hexanol, benzyl isobutyrate, 2,5-dimethylthiophene, isobutyl 2-butenoate, caprylonitrile, γ-nonalactone, nerol, trans-geraniol, 1-vinylheptanol, eucalyptol, terpinen-4-ol, dihydrocarveol, ethyl 2-methoxybenzoate, ethyl cyclohexancarboxylate, 2-ethylhexanal, ethylamylcarbinol, 2-octanol, ethyl methylphenylglycidate, diisobutyl ketone, cumarone, propyl isovalerate, isobutyl butanoate, isopentyl propanoate, 2-ethylbutyl acetate, 6-methyltetrahydroquinoline, eugenyl methyl ether, ethyl dihydrocinnamate, 3,5-dimethoxytoluene, toluene, ethyl benzoate, n-butyrophenone, α-terpineol, methyl 2-methylbenzoate, methyl 4-methylbenzoate, methyl 3-methylbenzoate, sec-butyl n-butyrate, 1,4-cineole, fenchyl alcohol, pinanol, cis-2-pinanol, 2,4-dimethylacetophenone, isoeugenol, safrole, methyl 2-octynoate, o-methylanisole, p-cresyl methyl ether, ethyl anthranilate, linalool, phenyl butyrate, ethylene glycol dibutyrate, diethyl phthalate, phenyl mercaptan, cumyl alcohol, 7-methylquinoline, 6-methylquinoline, 4-methylquinoline, 2-ethylbenzaldehyde, 4-ethylbenzaldehyde, o-ethylphenol, p-ethylphenol, m-ethylphenol, (+)-pulegone, 2,4-dimethylbenzaldehyde, isoxylaldehyde, ethyl sorbate, benzyl propionate, 1,3-dimethylbutyl acetate, isobutyl isobutanoate, 2,6-xylenol, 2,4-xylenol, 2,5-xylenol, 3,5-xylenol, methyl cinnamate, hexyl methyl ether, benzyl ethyl ether, methyl salicylate, butyl propyl ketone, ethyl amyl ketone, hexyl methyl ketone, 2,3-xylenol, 3,4-xylenol, cyclopentadecanolide and phenylethyl 2-phenylacetate.

If, in the context of the present invention, at least one perfume PF is used as active ingredient B, it is advantageous and preferable for four or more, preferably five or more, more preferably six or more or even seven or more different perfume components from the list of delayed bloom perfumes given above (“List I”) and/or four or more, preferably five or more, more preferably six or more or even seven or more different perfume components from the list of perfume components having a C Log P above 3 given above (“List I”) to be present in the perfume.

### 1.1.10 Insect-Repelling Agent IR

A further preferred active ingredient B is an insect-repelling agent IR (also referred to as “insect repellent” or “repellent”).

Chemically speaking, most repellent active ingredients belong to one of the four groups: amides, alcohols, esters or ethers.

Suitable for use as repellent in the present invention are liquids or solids having a relatively low melting point and a boiling point above 150° C., preferably liquids.

They evaporate slowly at room temperature.

Advantageously, the insect repellent can be assigned to a perfume type (the component best falls under both classes).

The most commonly used insect repellents include: DEET (N,N-diethyl-m-toluamide), essential oil of lemon-scented gum (Corymbia citriodora) and the active ingredient thereof p-menthane-3,8-diol (PMD), icaridin (CAS No.: 119515-38-7; also known as picaridin, D-limonene, Bayrepel and KBR 3023), nepetalactone (also known as “catmint oil”), citronella oil, permethrin, neem oil and bog-myrtle oil (oil from Myrica gale).

Preferred insect repellents from natural sources include: Achillea alpina (for example extracts from the leaves of Achillea alpina) α-terpinene, basil oil (oil from Ocimum basilicum), Callicarpa americana (for example extracts from the leaves of Callicarpa americana), camphor, carvacrol, castor oil (Ricinus communis), catmint oil (Nepeta species), cedar oil (Cedrus atlantica), celery extract (Apium graveolens), cinnamon (Cinnamomum Zeylanicum, leaf oil), citronella oil (Cymbopogon flexuosus), clove oil (Syzygium aromaticum), eucalyptus oil (70%+ eucalyptol, also known as cineole), fennel oil (Foeniculum vulgare), garlic oil (Allium sativum), geranium oil (also known as Pelargonium graveolens), lavender oil (Lavandula officinalis), essential lemon-scented gum oil (Corymbia citriodora) and the active ingredient thereof p-menthane-3,8-diol (“PMD”), common marigold oil (Calendula officinalis), marigold oil (Tagetes species), marjoram (Origanum majorana as insect repellent against Tetranychus urticae and Eutetranychus orientalis), neem oil (Azadirachta indica), oleic acid, peppermint (Mentha x piperita), pennyroyal (Mentha pulegium), pyrethrum (from Tanacetum species and Chrysanthemum species, in particular Chrysanthemum cinerariifolium and Tanacetum coccineum), rosemary oil (Rosmarinus officinalis), lantanas (Lantana such as in particular Lantana camara, as insect repellent against Helopeltis theivora), Millettia pinnata (likewise in particular as insect repellent against Helopeltis theivora), Solanum villosum berry juice, tea tree oil (Melaleuca alternfolia) and thyme (Thymus species), and mixtures thereof.

Preferred encapsulated insect repellents are mosquito repellents available from Celessence, Rochester, England.

Celessence Repel contains the active ingredient Saltidin™ and Celessence Repel Natural contains the active ingredient Citrepel™ 75.

Saltidin is a synthetic molecule originally developed by the Bayer Corporation.

Citrepel is produced from eucalyptus oils and has a high content of PMD.

A preferred unencapsulated insect repellent is Citriodiol™ from Citrefine.

### 1.1.11 Further Classes of Active Ingredients B

The active ingredient B may also be selected from the group of menthol-containing odorants and aromatherapy active ingredients, preferably selected from essential oils such as clary sage, eucalyptus, geranium, lavender, mace extract, neroli, nutmeg, spearmint, violet leaves and valerian.

The active ingredient B may also be selected from the group of humectants and/or softening agents for skin and/or hair, preferably selected from mineral oil, petrolatum, lauryl lactate and myristyl lactate, silicone oil, where dimethylpolysiloxane is a preferred silicone oil.

The active ingredient B may also be an antidandruff active ingredient selected in particular from the group consisting of zinc salts, in particular zinc pyrithione, zinc sulfate and hydrates thereof. It may also be selected from the group consisting of piroctone olamine, selenium sulfide, and azole antimicrobial agents, in particular climbazole.

In the embodiments of the present invention in which the active ingredient B comprises an antidandruff active ingredient, it is preferable for the proportion of all antidandruff agents, based on the total weight of all of the active ingredients B that the liquid cleaning composition R comprises, to lie in the range from 0.1% by weight to 5% by weight.

The active ingredient B may also be a silicone, in particular selected from the group consisting of polyalkylsiloxanes, polyarylsiloxanes, polyalkylarylsiloxanes, polyethersiloxane copolymer, aminosilicones, silicone rubbers, crosslinked silicone elastomers.

In the embodiments of the present invention in which the active ingredient B comprises a silicone, it is preferable for the proportion of all silicones, based on the total weight of all of the active ingredients B that the liquid cleaning composition R comprises, to be 0.01% by weight to 10% by weight.

The active ingredient B may also be a cationic polymer for hair care, in particular selected from cationic cellulose and cationic guar derivatives, preferably comprising a cationic guar flour derivative, preferably guar hydroxypropyltrimonium chloride. Such cationic polymers are commercially available from Rhone-Poulenc under the JAGUAR brand series, for example
i. JAGUAR C13S, which has a low degree of substitution of the cationic groups and a high viscosity;
ii. JAGUAR C15 with a medium degree of substitution and a low viscosity;
iii. JAGUAR C17 (high degree of substitution, high viscosity);
iv. JAGUAR C16, a hydroxypropylated cationic guar derivative having a low proportion of substituent groups and cationic quaternary ammonium groups,
v. JAGUAR 162, a highly transparent guar with a medium viscosity and a low degree of substitution.

Particularly preferred cationic polymers are JAGUAR C13S, JAGUAR C15, JAGUAR C17 and JAGUAR C16 and JAGUAR C162.

In the embodiments of the present invention in which the active ingredient B comprises a cationic polymer, it is preferable for the proportion of all cationic polymers, based on the total weight of all of the active ingredients B that the liquid cleaning composition R comprises, to be 0.01% by weight to 10% by weight, in particular 0.01% by weight to 5% by weight, preferably from 0.05% by weight to 1% by weight, more preferably from 0.08% by weight to 0.5% by weight.

If, in particular in a shampoo composition or a hand dishwashing detergent composition according to the invention, a cationic polymer is present, it is preferable for the cationic polymer to be present as an emulsion particle having an average diameter (D_{3,2} measured by light scattering using a Malvern particle size measuring instrument) of 2 μm or less.

### 1.1.13 Fluorescent Agent

The liquid cleaning composition R preferably comprises at least one fluorescent agent (=optical brightener). Fluorescent agents are well known and many such fluorescing agents are commercially available. Fluorescent agents are typically supplied and used in the form of their alkali metal salts, for example the sodium salts.

Preferred classes of fluorescent agents are: Distyryl biphenyl compounds, for example
Tinopal CBS-X {=(disodium 2,2′-([1,1′-biphenyl]-4,4′-diyldivinylene)bis(benzenesulfonate)), diaminostilbenedisulfonic acid compounds, for example
Tinopal DMS pure Xtra {=the disodium salt of 4,4′-bis{[(4-anilino-6-morpholino-1,3,5-triazin-2-yl)]amino}stilbene-2,2′-disulfonate} and Blankophor (trademark) HRH and pyrazoline compounds, for example Blankophor SN. Preferred fluorescence compounds are also those having the following CAS numbers:
CAS No.: 3426-43-5; CAS No.: 35632-99-6; CAS No.: 24565-13-7; CAS No.: 12224-16-7; CAS No.: 13863-31-5; CAS No.: 4193-55-9; CAS No.: 16090-02-1; CAS No.: 133-66-4; CAS No.: 68444-86-0; CAS No.: 27344-41-8.

Most preferred as fluorescent agents are:
sodium 2-(4-styryl-3-sulfophenyl)-2H-naptho[1,2-d]triazole (CAS No: 6416-68-8), disodium 4,4′-bis{[(4-anilino-6-(N-methyl-N-2-hydroxyethyl)amino-1,3,5-triazin-2-yl)]amino}stilbene-2,2′-disulfonate (CAS No.: 13863-31-5),
disodium 4,4′-bis{[(4-anilino-6-morpholino-1,3,5-triazin-2-yl)]amino}stilbene-2,2′-disulfonate (CAS No.: 16090-02-1),
disodium 4,4′-bis(2-sulfostyryl)biphenyl (CAS No.: 27344-41-8).

In embodiments in which the liquid cleaning composition R comprises at least one fluorescent agent, the total content of all of the fluorescent agents that the liquid cleaning composition R comprises is in particular 0.0001% by weight to 2% by weight, preferably 0.005% by weight to 0.5% by weight, more preferably 0.05% by weight to 0.25% by weight, based in each case on the total weight of the liquid cleaning composition R.

Alternatively, in these embodiments, the total content of all of the fluorescent agents that the liquid cleaning composition R comprises is in particular 0.0001 g/l to 0.1 g/1, preferably 0.001 g/l to 0.02 g/1, based in each case on the total volume of the liquid cleaning composition R.

### 1.1.14 Enzyme E

The liquid cleaning composition R preferably comprises at least one enzyme E.

The preferred amount of the respective enzyme E in the liquid cleaning composition R preferably lies in the range from 0.0001% by weight to 0.1% by weight, based in each case on the total weight of the liquid cleaning composition R.

The preferred amount of the respective enzyme E in the liquid cleaning composition R preferably lies in the range from 0.01 ppm to 10 ppm, in particular 0.05 to 1 ppm, based in each case on the total weight of the liquid cleaning composition R.

The amounts of the enzyme E preferred in the composition preferably refer to the amount of enzyme as pure protein.

The enzyme E is selected in particular from those mentioned in WO 2012/010405 A1, preferably from the group consisting of proteases, α-amylases, cellulases, esterases, lipases, peroxidases/oxidases, pectate lyases, mannanases, cutinases.

Preferably, the enzyme E is selected from the group consisting of proteases, α-amylases, cellulases and lipases; most preferably, the enzyme E is a lipase.

For example, a liquid cleaning agent R can be obtained by mixing the following composition R* as a premix with the remaining components of the liquid cleaning agent:

In one embodiment, R* is a mixture containing an effective amount of a surfactant system T² and of an enzyme system E², characterized
in that the surfactant system T² contains at least 1% by weight (based on the cleaning composition), preferably at least 5% by weight (based on the total weight of the surfactant system T²), of at least one biosurfactant BT, where BT is selected from the group of the glucolipids G and is preferably of bacterial or fungal origin, and
in that the enzyme system E² contains at least one enzyme E of bacterial origin, where E is selected from the group consisting of cellulases, lipases, esterases, peroxidases/oxidases, oxidoreductases, pectases, lyases, mannanases.

In another embodiment, R* is a mixture containing an effective amount of a surfactant system T² and of an enzyme system E², characterized
in that the surfactant system T² contains at least 1% by weight (based on the cleaning composition), preferably at least 5% by weight (based on the total weight of the surfactant system T²), of at least one biosurfactant BT, where BT is selected from the group of the glucolipids G and is preferably of bacterial or fungal origin, and
in that the enzyme system E² contains at least one enzyme E of fungal origin, where E is selected from the group consisting of cellulases, lipases, esterases, peroxidases/oxidases, oxidoreductases, pectases, lyases, mannanases.

In another embodiment, R* is a mixture containing an effective amount of a surfactant system T² and of an enzyme system E², characterized
in that the surfactant system T² contains at least 1% by weight (based on the cleaning composition), preferably at least 5% by weight (based on the total weight of the surfactant system T²), of at least one biosurfactant BT, where BT is selected from the group of the glucolipids G and is preferably of bacterial or fungal origin,
   and where T² also comprises at least one anionic surfactant, the anionic surfactant preferably being selected from the group of the alkyl sulfates, alkyl ether sulfates, optionally alkoxylated sulfosuccinates, optionally alkoxylated methyl sulfosuccinates, optionally alkoxylated sulfonates, optionally alkoxylated glycinates, optionally alkoxylated glutamates, optionally alkoxylated isethionates, optionally alkoxylated
   carboxylates, optionally alkoxylated anisates, optionally alkoxylated levulinates, optionally alkoxylated tartrates, optionally alkoxylated lactylates, optionally alkoxylated taurates, optionally alkoxylated alaninates, optionally alkoxylated phosphates, optionally alkoxylated sulfoacetates, optionally alkoxylated sulfosuccinamates, optionally alkoxylated sarcosinates and optionally alkoxylated phosphonates, and the anionic surfactant more preferably still being selected from the group consisting of optionally alkoxylated sulfonates, alkyl sulfates and alkyl ether sulfates;
   and where T² optionally also comprises at least one further biosurfactant, the further biosurfactant preferably being selected from the group of the sophorolipids, derivatives of sophorolipids (such as those described in EP 3 043 613 A1 or EP 4 317 448 A1), rhamnolipids;
in that the enzyme system E² contains at least one enzyme E of fungal or bacterial, preferably bacterial, origin, E being selected from the group of the peptidases, preferably serine proteases of EC 3.4.21 or metalloproteases of EC 3.4.24, these preferably being selected from the serine proteases of EC 3.4.21 (for example Alcalase) or metalloproteases of EC 3.4.24 (for example Neutrase) preferably mentioned in WO 2016/146497 A1.

Lipases suitable as enzyme E include those of bacterial or fungal origin.

These also include chemically modified mutants or mutants produced by protein manipulation.

Preferred lipases suitable as enzyme E include lipases from Humicola (synonym: Thermomyces), for example from H. lanuginosa (T lanuginosus), as described in EP 0 258 068 A2 and EP 0 305 216 A1, or from H. insolens, as in WO 96/13580 A1, a Pseudomonas lipase, for example from P. alcaligenes or
P. pseudoalcaligenes (EP 0 218 272 A1), P. cepacia (EP 0 331 376 A2), P. stutzeri (GB 1,372,034 A1), P. fluorescens, Pseudomonas sp. strain SD 705 (EP 0 721 981 A1 and EP 0 812 910 A1), P. wisconsinensis (CA 2,202,553 A1), a Bacillus lipase, for example from B. subtilis (V. Dartois et al., Biochim Biophys Acta 1992, 1131, 253-260), B. stearothermophilus (JP 564-74992 A) or B. pumilus (WO 91/16422 A1).

Other examples of lipase variants suitable as enzyme E are those described in WO 92/05249 A1 WO 94/01541 A1, EP 0 407 225 A1, EP 0 260 105 A2, WO 95/35381 A1, WO 96/00292 A1, WO 95/30744 A1, WO 94/25578 A1, WO 95/14783 A1, WO 95/22615 A1, WO 97/04079 A1, WO 97/07202 A1, WO 00/60063 A1.

Preferred commercially available lipase enzymes include Lipolase™ and Lipolase Ultra™ Lipex™ and Lipoclean™ (Novozymes A/S).

As enzyme E, it is also possible to select a phospholipase which is classified as EC 3.1.1.4 and/or EC 3.1.1.32. The term “phospholipase” used herein refers to an enzyme that has activity against phospholipids.

Phospholipids such as lecithin or phosphatidylcholine consist of glycerol, which is esterified with two fatty acids at an outer (sn-1) and a middle (sn-2) position and with phosphoric acid at the third position; the phosphoric acid can in turn be esterified with an amino alcohol. Phospholipases are enzymes involved in the hydrolysis of phospholipids.

A distinction can be made between a number of phospholipase activity types, including phospholipases A₁ and A₂, which hydrolyse a fatty acyl group (in positions sn-1 and sn-2, respectively) to form lysophospholipid, and lysophospholipase (or phospholipase B), which can hydrolyse the remaining fatty acyl group in the lysophospholipid.

Phospholipase C and phospholipase D (phosphodiesterases) release diacylglycerol and phosphatidic acid, respectively.

Protease enzymes hydrolyse bonds within peptides and proteins. During laundry washing, this results in improved removal of protein- or peptide-containing stains.

Examples of protease families suitable for use as enzyme E are aspartic acid proteases, cysteine proteases, glutamic acid proteases, asparagine peptide lyase, serine proteases, metalloproteases and threonine proteases.

Such protease families are described in the MEROPS peptidase database (https://www.ebi.ac.uk/merops/).

Serine proteases, metalloproteases, and in particular serine proteases, are preferred as enzyme E.

Such metalloproteases and serine proteases preferred as enzyme E are disclosed in WO 2016/146497 A1. This document for example discloses serine proteases of EC 3.4.21 and metalloproteases of EC 3.4.24.

Serine proteases of the subtilase type are more preferred as enzyme E.

The term “subtilases” refers to a subgroup of serine proteases as per R. J. Siezen et al., Protein Engineering 1991, 4, 719-737 and R. J. Siezen & J. A. Leunissen, Protein Science 1997, 6, 501-523.

Serine proteases are a subgroup of proteases which are characterized in that they possess in the active site a serine which forms a covalent adduct with the substrate.

The subtilases can be divided into six subgroups, namely the subtilisin family, the thermitase family, the proteinase K family, the antibiotic peptidase family, the kexin family and the pyrolysin family.

Examples of subtilases suitable within the context of the invention as enzyme E are those derived from Bacillus (such as Bacillus lentus, B. alkalophilus, B. subtilis, B. amyloliquefaciens, Bacillus pumilus and Bacillus gibsonii), described in U.S. Pat. No. 7,262,042 B2 and WO 2009/021867 A2. Further suitable subtilases are subtilisin lentus, subtilisin Novo, subtilisin Carlsberg, subtilases from Bacillus lichenformis, subtilisin BPN′, subtilisin 309, subtilisin 147 and subtilisin 168, described in WO 89/06279 A1, and protease PD138, described in WO 93/18140 A1.

Other proteases suitable within the context of the invention as enzyme E are those described in WO 01/16285 A2 and WO 02/16547 A2.

Examples of trypsin-like proteases suitable as enzyme E are trypsin (for example from pig or cattle) and the Fusarium proteases described in WO 89/06270 A1, WO 94/25583 A1 and WO 2005/040372 A1, and also the chymotrypsin proteases from Cellulomonas described in WO 2005/052161 A2 and WO 2005/052146 A2.

The protease is most preferably a subtilisin (EC 3.4.21.62).

The subtilisin is preferably obtained from Bacillus, preferably Bacillus lentus, B. alkalophilus, B. subtilis, B. amyloliquefaciens, Bacillus pumilus and Bacillus gibsonii, as described in U.S. Pat. Nos. 6,312,936 B1, 5,679,630 A, 4,760,025 A, 7,262,042 B2 and WO 2009/021867 A2. The subtilisin is most preferably obtained from Bacillus gibsonii or Bacillus lentus.

Commercially available protease enzymes suitable as enzyme E include those having the trade names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase®, Esperase® and Carnival®; they might also be sold as Ultra® or Evity® (Novozymes A/S).

The enzyme E that the liquid cleaning composition R comprises may be a cutinase classified under EC 3.1.1.74.

The cutinase used according to the invention may be of any origin.

Cutinases are preferably of microbial origin, in particular bacterial, fungal or yeast origin.

Amylases (α-amylase and/or β-amylase) suitable as enzyme E within the context of the invention include those of bacterial or fungal origin.

These also include chemically modified mutants or mutants produced by protein manipulation. Amylases suitable as enzyme E within the context of the invention include for example the α-amylases obtained from Bacillus, for example a special strain of B. lichenformis, described in more detail in GB 1,296,839 A, or the Bacillus sp. strains disclosed in WO 95/26397 A1 or WO 00/60060 A2.

Commercially available amylases are Duramyl™, Termamyl™, Termamyl Ultra™, Natalase™ Stainzyme™, Fungamyl™ and BAN™ (Novozymes A/S), Rapidase™ and Purastar™ (from Genencor International Inc.).

Cellulases suitable as enzyme E within the context of the invention include those of bacterial or fungal origin.

These also include chemically modified mutants or mutants produced by protein manipulation. Suitable cellulases include cellulases of the genera Bacillus, Pseudomonas, Humicola, Fusarium, Thielavia, Acremonium, for example the fungal cellulases from Humicola insolens, Thielavia terrestris, Myceliophthora thermophila and Fusarium oxysporum, disclosed in U.S. Pat. Nos. 4,435,307 A, 5,648,263 A, 5,691,178 A, 5,776,757 A, WO 89/09259 A1, WO 96/29397 A1 and WO 98/12307 A1.

Commercially available cellulases include Celluzyme™, Carezyme™, Celluclean™ Endolase™, Renozyme™ (Novozymes A/S), Clazinase™ and Puradax HA™ (Genencor International Inc.) and KAC-500(B)™ (Kao Corporation).

Preference is given to Celluclean™

Peroxidases/oxidases suitable as enzyme E within the context of the invention include those of plant, bacterial or fungal origin.

These also include chemically modified mutants or mutants produced by protein manipulation. Examples of useful peroxidases include peroxidases from Coprinus, for example from C. cinereus, and variants thereof as described in WO 93/24618 A1, WO 95/10602 A1 and WO 98/15257 A1.

Commercially available peroxidases include Guardzyme™ and Novozym™ 51004 (Novozymes A/S).

Further enzymes suitable as enzyme E within the scope of the invention are disclosed in WO 2009/087524 A1, WO 2009/090576 A2, WO 2009/107091 A2, WO 2009/111258 A2 and WO 2009/148983 A1.

Suitable enzymes E may be present as a mixture or as a combination of two or more enzymes.

An enzyme E present in the liquid cleaning composition R may be stabilized by stabilizers. In one embodiment, the liquid cleaning composition R therefore comprises, in addition to the at least one enzyme E, also at least one enzyme stabilizer.

Enzyme stabilizers suitable within the context of the invention are selected from the group consisting of polyols (such as propylene glycol or glycerol), sugars, sugar alcohols, lactic acid, boric acid, boric acid derivatives (for example aromatic boric acid esters) or phenylboronic acid derivatives such as 4-formylphenylboronic acid. The corresponding liquid cleaning composition R can be formulated as in WO 92/19709 A1 or WO 92/19708 A1.

Since, in one embodiment, the liquid cleaning composition R, in addition to anionic surfactants and glucolipid G, may also comprise peptidases such as serine proteases of EC 3.4.21 or metalloproteases of EC 3.4.24, rhamnolipids, sophorolipids and/or other biosurfactants can also be used for stabilization of these enzymes E, as described in WO 2016/146497 A1.

### 1.1.12 Further Possible Constituents

The liquid cleaning composition R may comprise further constituents, in particular selected from the following points i. to iv.:
i. vegetable oils: peanut oil, canola oil, castor oil, cocoa butter, coconut oil, maize oil, cotton seed oil, olive oil, palm kernel oil, rapeseed oil, safflower oil, sesame oil and soybean oil;
ii. esters: butyl myristate, cetyl palmitate, decyl oleate, glyceryl laurate, glyceryl ricinoleate, glyceryl stearate, glyceryl isostearate, hexyl laurate, isobutyl palmitate, isocetyl stearate, isopropyl isostearate, isopropyl laurate, isopropyl linoleate, isopropyl myristate, isopropyl palmitate, isopropyl stearate, propylene glycol monolaurate, propylene glycol ricinoleate, propylene glycol stearate and propylene glycol isostearate;
iii. animal fats: acetylated lanolin alcohols, lanolin, lard, mink oil and tallow;
iv. fatty acids and alcohols: behenic acid, palmitic acid, stearic acid, behenyl alcohol, cetyl alcohol, eicosanyl alcohol and isocetyl alcohol;
v. active ingredients in hand-washing and textile cleaning compositions that are particularly suitable for suspension, such as opacifiers and visual indicators, either with or without functional ingredients and other ingredients embedded therein, antimicrobial agents;
vi. polyester-based soil release polymers, hydrotropes, opacifiers, dyes, enzymes, further surfactants such as nonionic, cationic and/or amphoteric surfactants, plasticizers, polymers for preventing the redeposition of dirt, bleaches, bleach activators and bleach catalysts, antioxidants, pH regulators and buffers, thickeners, external structuring agents for rheology modification and visual indicators known to those skilled in the art;
vii. perfume (unencapsulated or encapsulated as described under 1.1.8);
viii. polymers, polyesters, soil release polymers/polymers for preventing the redeposition of dirt, hydrotropes, opacifiers, preservatives;
ix. dyes (for example dyes and pigments);
x. enzymes (e.g. proteases, α-amylases, cellulases, lipases; peroxidases/oxidases, pectate lyases and mannanases, or mixtures thereof);
xi. plasticizers, bleaches, bleach activators and bleach catalysts;
xii. antioxidants, pH regulators and buffers.

The enzymes may for example be selected from proteases (for example those described in WO 2016/146497 A1), α-amylases, cellulases, lipases, peroxidases/oxidases, pectate lyases, cutinases and mannanases, or mixtures thereof.

The enzymes used may also be the enzymes described in WO 2012/010405 A1.

The liquid cleaning composition R may be in the form of a gel or a liquid. It may be filled into a commercially available container, for example a plastic bottle made from polyethylene terephthalate (=“PET”), polypropylene, or glass, ceramic. These containers/bottles may then have an outlet device, for example a spout, an outlet opening with a hinged closure, through which the liquid cleaning composition R can be withdrawn.

### 1.1.15 Builder and Complexing Agent K

The liquid cleaning composition R preferably comprises at least one complexing agent (“sequestrant”) K.

Builder materials can be useful in particular in liquid detergent compositions for washing by hand.

Builder materials may be selected from 1) calcium sequestration materials, 2) precipitation materials, 3) calcium ion exchange materials, and 4) mixtures thereof.

Examples of calcium sequestering agent builder materials are alkali metal polyphosphates such as sodium tripolyphosphate and organic sequestering agents such as ethylenediaminetetraacetic acid.

Examples of precipitating builder materials are sodium orthophosphate and sodium carbonate.

Examples of calcium ion exchanger builder materials include the various types of water-insoluble crystalline or amorphous aluminosilicates, of which zeolites are the most well-known representatives, for example zeolite A, zeolite B (also known as zeolite P), zeolite C, zeolite X, zeolite Y, and also P-type zeolite, as described in EP 0 384 070 A2.

The liquid cleaning composition R may also comprise 0.1% by weight to 65% by weight, based on the total weight of R, a builder or complexing agent such as ethylenediaminetetraacetic acid, diethylenetriaminepentaacetic acid, alkylsuccinic or alkenylsuccinic acid, nitrilotriacetic acid, or the further builders mentioned below.

Many builders also act as bleach stabilizers due to their ability to complex metal ions.

Zeolite and carbonate (including bicarbonate and sesquicarbonate) are preferred builders.

The liquid cleaning composition R may contain, as builder, a crystalline aluminosilicate, preferably an alkali metal aluminosilicate, more preferably a sodium aluminosilicate. Typically, it is present in an amount of less than 15% by weight, based on the total weight of R.

Aluminosilicates are materials having the general formula (0.8-1.5 M₂₀)Al₂O₃ (0.8-6 SiO₂), where M is a monovalent metal ion, preferably an alkali metal ion, more preferably still potassium or sodium, most preferably sodium.

These materials contain some bound water and must have a calcium ion exchange capacity of at least 50 mg CaO/g.

The preferred sodium aluminosilicates contain 1.5 to 3.5 SiO₂ units in the above formula. They can easily be prepared by a reaction between sodium silicate and sodium aluminate, as described in detail in the literature.

The ratio of surfactants to aluminosilicate (if present) is preferably greater than 5:2, more preferably greater than 3:1.

Alternatively or in addition to the aluminosilicate builders, it is possible to use phosphate builders.

In this field, the term “phosphate” encompasses diphosphate, triphosphate and phosphonate species.

Other forms of builders include silicates, such as soluble silicates, metasilicates, sheet silicates (for example SKS-6 from Hoechst).

The liquid cleaning composition R is preferably a phosphate-free detergent formulation, i.e. it contains less than 1% by weight of phosphate, based on the total weight of R.

If a builder is present, the liquid cleaning composition R is preferably of a carbonate-based structure.

The liquid cleaning composition R preferably comprises at least one complexing agent (“sequestrant”) K.

In the embodiments in which the liquid cleaning composition R comprises at least one complexing agent (=“sequestrant”) K, it is preferable for the amount of all complexing agents that the liquid cleaning composition R comprises to be in the range from 0.1% by weight to 5% by weight, preferably 0.25% by weight to 4% by weight, more preferably 0.5% by weight to 2.5% by weight, based in each case on the total weight of the liquid cleaning composition R.

Preferred complexing agents K include phosphonic acids or their salts. K is preferably from the group consisting of etidronic acid (“HEDP”; CAS No.: 2809-21-4), diethylenetriaminepenta(methylenephosphonic acid) (“DTPMP”; CAS No.: 15827-60-8), hexamethylenediaminetetra(methylenephosphonic acid) (“HDTMP”; CAS No. of the sodium salt: 56744-47-9; CAS No. of the potassium salt: 38820-59-6); aminotrimethylenephosphonic acid (“ATMP”; CAS No.: 6419-19-8); ethylenediaminetetra(methylenephosphonic acid) (“EDTMP”; CAS No. of the sodium salt: 15142-96-8); tetramethylenediaminetetra(methylenephosphonic acid) (“TDTMP”; CAS No.: 56399-18-9); and phosphonobutanetricarboxylic acid (“PBTC”; CAS No.: 37971-36-1). The complexing agent K is preferably present in acid form. This means that it is then a phosphonic acid.

The most preferred complexing agent K is HEDP.

### 1.1.16 Further Polymers P_{X}

The liquid cleaning composition R may comprise at least one further polymer P_{X} that is preferably different from P_{C}. P_{X} is accordingly preferably not an alkoxylated polyamine or a polyester soil release polymer.

The polymer P_{X} is preferably selected from the group consisting of carboxymethylcellulose, polyethylene glycol, polyvinyl alcohol, polycarboxylates [in particular poly(meth)acrylates], copolymers of maleic acid and (meth)acrylic acid and copolymers of lauryl methacrylate and acrylic acid.

The polymer P_{X} may also be a polymer that is intended to prevent dye deposits, such as for example poly(vinylpyrrolidone), poly(vinylpyridine N-oxide) and poly(vinylimidazole).

### 1.1.17 Shading Dye F_{S}

The liquid cleaning composition R preferably comprises at least one shading dye F_{S}.

In this preferred embodiment, it is more preferable still for the liquid cleaning composition R to comprise the shading dye in an amount of from 0.0001% by weight to 0.5% by weight, more preferably 0.001% by weight to 0.1% by weight, based on the total weight of the liquid cleaning composition R. Depending on the nature of the shading dye F_{S}, there are preferred ranges, depending on the efficacy of the shading dye, which in turn depends on the class and the particular efficacy within a particular class.

The liquid cleaning composition R comprises, in particular in the embodiments of the present invention in which it is used as a detergent for textiles or bleach for textiles, at least one shading dye F_{S}.

Shading dyes F_{S} for use in detergents preferably have an absorption coefficient at the maximum absorption in the visible range (400 nm to 700 nm) of more than 5000 L mol⁻¹ cm⁻¹, preferably greater than 10 000 L mol⁻¹ cm⁻¹.

The dyes F_{S} have a blue or violet colour.

Preferred shading dye chromophores are azo, azine, anthraquinone, and triphenylmethane.

Azo, anthraquinone, phthalocyanine and triphenylmethane dyes preferably carry an anionic net charge or are uncharged.

Azines preferably carry an anionic or cationic net charge.

Blue or violet hues are deposited in the fabric during washing or rinsing and give the fabric a visible hue.

In this respect, the dye imparts a white material with a blue or violet colour with a hue angle of 240 to 345, preferably from 250 to 320 and most preferably from 250 to 280. The white material used in this test consists of bleached, unmercerized woven cotton cloth.

Shading dyes F_{S} suitable within the context of the present invention are described in WO 2005/003274 A1, WO 2006/032327 A1, WO 2006/032397 A1, WO 2006/027086 A1, WO 2008/017570 A1, WO 2008/141880 A1, WO 2009/132870 A1, WO 2009/141173 A1, WO 2010/099997 A1, WO 2010/102861 A1, WO 2010/148624 A1, WO 2008/087497 A1, WO 2011/011799 A2, WO 2012/054820 A1, WO 2013/142495 A1 and WO 2013/151970 A1.

Monoazo dyes preferably contain a heterocyclic ring and most preferably are thiophene dyes. The monoazo dyes are preferably alkoxylated and are preferably uncharged or anionically charged at pH 7.

Alkoxylated thiophene dyes are discussed in WO 2013/142495 A1 and WO 2008/087497 A1. Preferred examples of thiophene dyes are listed below:

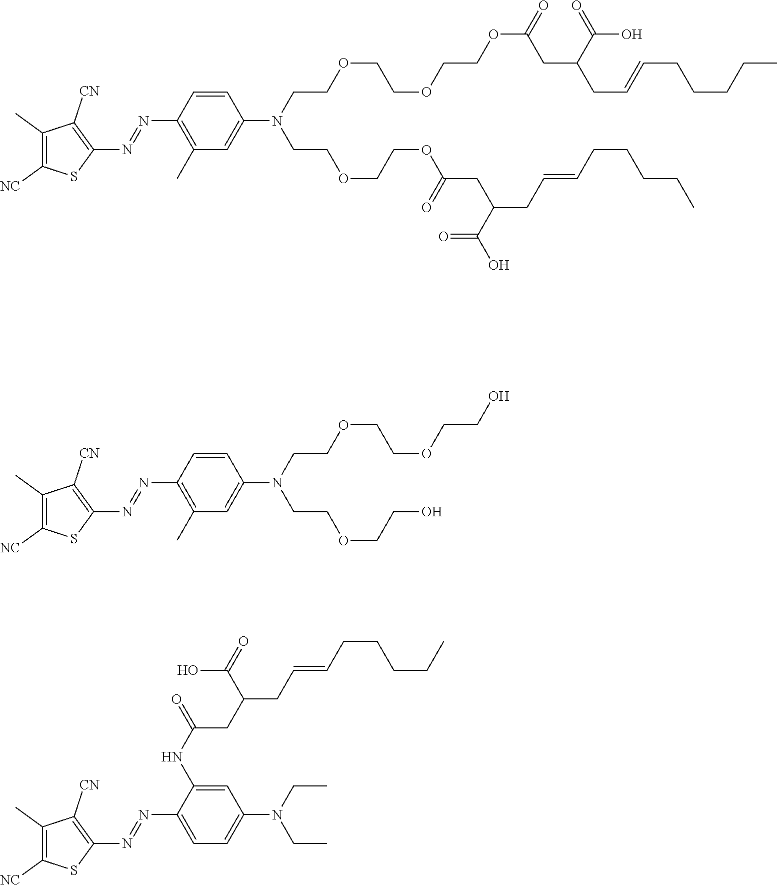

Bis-azo dyes are preferably sulfonated bis-azo dyes.

Preferred examples of sulfonated bis-azo compounds are Direct Violet 7 (CAS No.: 6227-10-7), Direct Violet 9 (CAS No. of the sodium salt: 6227-14-1), Direct Violet 11, Direct Violet 26, Direct Violet 31, Direct Violet 35, Direct Violet 40, Direct Violet 41, Direct Violet 51, Direct Violet 66, Direct Violet 99 and alkoxylated derivatives of these Direct Violet dyes.

Alkoxylated bis-azo dyes are discussed in WO 2012/054058 A1 and WO 2010/151906 A1.

An example of an alkoxylated bis-azo dye is:

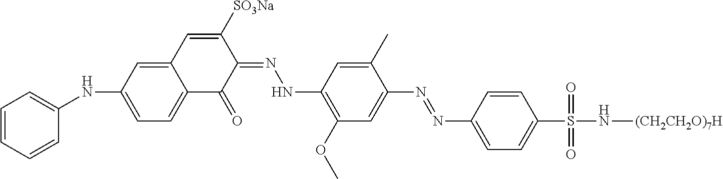

Thiophene dyes are available from Milliken under the trade names Liquitint Violet DD and Liquitint Violet ION.

Azine dyes are preferably selected from sulfonated phenazine dyes and cationic phenazine dyes. Preferred examples are Acid Blue 98, Acid Violet 50, dye having the CAS No.: 72749-80-5, Acid Blue 59 and the phenazine dye selected from:

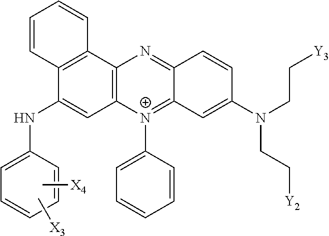

where X₃ is selected from: —H; —F; —CH₃; —C₂H₅; —OCH₃; and —OC₂H₅;
where X₄ is selected from: —H; —CH₃; —C₂H₅; —OCH₃; and —OC₂H₅;
Y₂ and Y₃ are each independently selected from:
—OH; —OCH₂CH₂OH; —CH(OH)CH₂OH; —OC(O)CH₃; and C(O)OCH₃.

As indicated above, the shading dye is a blue or violet shading dye.

A mixture of shading dyes may be used.

The shading dye is particularly preferably a reactive blue anthraquinone dye which is covalently bonded to an alkoxylated polyethyleneimine.

The alkoxylation is preferably selected from ethoxylation and propoxylation; propoxylation is most preferred.

Preferably, 80 mol % to 95 mol % of the N—H groups in the polyethyleneimine are replaced by propoxylation by isopropyl alcohol groups.

Preferably, the polyethyleneimine has a molecular weight of 600 to 1800 before the reaction with the dye and the propoxylation.

An exemplary structure of a preferred reactive anthraquinone which is covalently bonded to a propoxylated polyethyleneimine is:

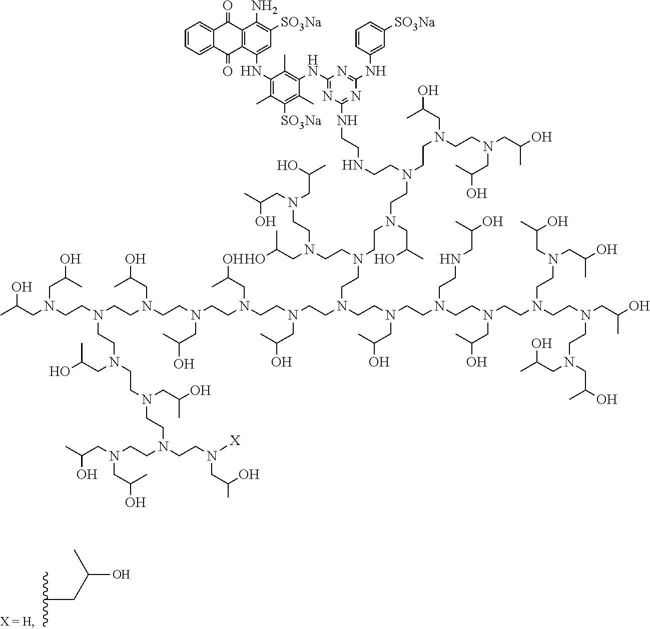

### 1.1.18 Perfumes

Perfume may expediently be present in the liquid cleaning composition R as free perfume oil or as encapsulated perfume.

The liquid cleaning composition R may accordingly comprise at least one perfume PF or a perfume mixture M_{PF}. In addition to the encapsulated form described under 1.1.9, PF or M_{PF} may accordingly also be present in unencapsulated form in the liquid cleaning composition R. The liquid cleaning composition R may contain 0.001% by weight to 3% by weight of preferably unencapsulated perfume PF or M_{PF}, preferably 0.1% by weight to 2% by weight of preferably unencapsulated perfume PF or M_{PF}, based in each case on the total weight of the liquid cleaning composition R.

### 1.2 Production of the Liquid Cleaning Composition R

The liquid cleaning composition R can be produced by mixing the constituents in a suitable mixer. For the production of a liquid cleaning composition R comprising active ingredient capsules W_{K}, it is expedient to initially provide at least one amphoteric surfactant T_{Amph} and at least one glucolipid G and then to mix W_{K} therein.

It has been found that the glucolipids stabilize the liquid cleaning composition R thus obtained better than for example the rhamnolipids or sophorolipids, when adding the respective substance in the same amount.

This results in a more homogeneous and more stable liquid cleaning composition R, since the active ingredient capsules do not settle as quickly in the liquid cleaning composition R as in the dispersions obtained according to the prior art, WO 2014/173659 A1.

The liquid cleaning composition R includes b) water; in particular, the liquid cleaning composition R comprises water in the range from 1% by weight to 99% by weight, more preferably in the range from 2% by weight to 90% by weight, more preferably still in the range from 3% by weight to 80% by weight, more preferably still in the range from 4% by weight to 75% by weight, more preferably still in the range from 5% by weight to 70% by weight, more preferably still in the range from 6% by weight to 65% by weight, more preferably still in the range from 7% by weight to 60% by weight, more preferably still in the range from 8% by weight to 55% by weight, more preferably still in the range from 9% by weight to 50% by weight, more preferably still in the range from 10% by weight to 40% by weight, more preferably still in the range from 15% by weight to 35% by weight, more preferably still in the range from 20% by weight to 30% by weight, more preferably still in the range from 21% by weight to 25% by weight, based in each case on the total weight of the liquid cleaning composition R.

The liquid cleaning composition R is particularly suitable for washing in water having a high water hardness, preferably of greater than 5° fH (“fH”=“French degrees”), preferably greater than 40° fH, better still greater than 90° fH, where “1° fH” corresponds to 10 μg of CaCO₃ per 1 litre of water.

### 2. Process for Treating a Substrate

The present invention also relates to the use of the liquid cleaning composition R as a laundry detergent, shampoo or as a dishwashing detergent, in particular as a hand dishwashing detergent.

The present invention in a second aspect relates to a process for treating, preferably for washing and/or rinsing, a substrate S using a wash liquor, comprising the production of a wash liquor by mixing the liquid cleaning composition R according to the invention with water, and contacting the wash liquor with the substrate S.

In a preferred embodiment of the second aspect, the present invention relates to a process for treating a substrate S using a wash liquor, comprising the production of a wash liquor by mixing the liquid cleaning composition R according to the invention with water in container, preferably a bathtub, a bucket or a washbasin, and contacting the wash liquor with the substrate S. The substrate S is preferably the body of the user or a woven fabric, nonwoven, a hard surface, preferably dishware, and the substrate S is preferably dishware which is washed by hand.

The substrate S is in particular selected from an object and a part of the human or animal body; preferably, S is an object. Preferred objects are selected from woven fabrics, nonwovens, objects with hard surfaces, preferably dishware.

However, the liquid cleaning composition R according to the invention may also be used for personal care, for example as shampoo. Preferred parts of the human or animal body are then the teeth, hair or skin.

The process according to the second aspect of the invention is preferably one in which S is an object which is washed and/or rinsed by hand, the object preferably being selected from woven fabrics, nonwovens, objects with hard surfaces, and most preferably is dishware.

The pH of the water in the wash liquor preferably lies in the range from 3 to 9, more preferably still 4 to 8, more preferably still 5.5 to 7.5, measured at 25° C.

The liquid cleaning composition R is particularly suitable for washing in water having a high water hardness, preferably of greater than 5° fH, preferably greater than 40° fH, better still greater than 90° fH, where “1° fH” corresponds to 10 μg of CaCO₃ per 1 litre of water.

In one embodiment, the liquid cleaning composition R comprises no builders, but in a preferred embodiment may comprise these (as described in 1.1.15).

The substrate S is preferably selected from an object and a part of the human or animal body, with S preferably being an object.

### 3. Use

In one aspect, the present invention also relates to the use of at least one glucolipid G for increasing the viscosity of a liquid cleaning composition, in particular the liquid cleaning composition R according to the invention, having a pH in the range from 3.0 to 6.5, in particular 3.5 to 6.5, more preferably 4.0 to 6.5, more preferably 4.25 to 6.5, more preferably 4.5 to 6.5, more preferably 4.75 to 6.5, more preferably still 5.0 to 6.5, yet more preferably still 5.25 to 6.5, yet more preferably still 5.5 to 6.5, yet more preferably still 5.75 to 6.5, yet more preferably still 5.80 to 6.5, yet more preferably still 6.0 to 6.5, yet more preferably still 6.1 to 6.4, yet more preferably still 6.2 to 6.3.

The at least one glucolipid G may also be used in the liquid cleaning composition R according to the invention, wherein the liquid cleaning composition R according to the invention is used as a handwash detergent in order to give the consumer a sensory impression of hand mildness, where preferably the sensory impression of hand mildness remains even after the subsequent drying of the hands after the end of the hand wash process.

The handwash detergent is in one embodiment a hand dishwashing composition or a liquid detergent composition for hand washing.

In another embodiment, the handwash detergent is a liquid detergent composition, preferably an aqueous detergent composition, in particular for textiles.

Unless stated otherwise, pH values are measured at 25° C. within the context of the present invention.

The compositions of the invention are preferably untreated.

Unless stated otherwise, all reported percentages (%) are percentages by mass.

The examples listed below describe the present invention by way of example without any intention of limiting the invention, the scope of application of which is apparent from the entirety of the description, to the embodiments mentioned in the examples.

### EXAMPLES

The following materials were used in the tests:

Glucolipid (“GL”) is obtained as described in Examples 1 to 3 of WO 2019/154970 A1. It was employed as a 50% by weight solution.

As rhamnolipid (“RL”), di- or monorhamnolipid is used.

Dirhamnolipids (“diRL”) are obtained according to Example 1 of EP 3 061 442 A1. They are employed as a 50% by weight aqueous solution.

Monorhamnolipids (“monoRL”) are obtained according to Example 2 of EP 3 061 442 A1. They are employed as a 75% by weight aqueous solution.

“Tinopal CBS-X” is the optical brightener (disodium 2,2′-([1,1′-biphenyl]-4,4′-diyldivinylene)bis(benzenesulfonate) (CAS No.: 27344-41-8).

As anionic surfactant, sodium lauryl ether sulfate (“SLES 3EO”) (CAS No.: 68891-38-3) is used. In addition, as anionic surfactant, LAS (linear alkylbenzenesulfonate; CAS Number 68411-30-3) is used (is employed in the acid form).

“TEA” is triethanolamine (CAS No.: 102-71-6).

“MIT” is methylisothiazolinone (CAS No: 2682-20-4).

“BIT” is benzisothiazolinone (CAS No.: 2634-33-5).

Cocamidopropylbetaine (“CAPB”; TEGO® Betain F 50, 38% by weight, Evonik Industries AG) is used as an amphoteric surfactant.

HP 20 is an ethoxylated polyethylene polymer (available as “Sokalan® HP 20” from BASF). “Texcare” is a nonionic polyester soil release polymer (available as TexCare® SRN 170 Terra from Clariant).

As perfume, active ingredient capsules are used which release the active ingredient under the action of friction. The capsules are made from melamine-formaldehyde, the active ingredient is an aroma substance (“Aroma Ball Type 1 and Aroma Ball S-series; Polychrome; Korea”).

Alternatively, capsules which release the active ingredient under the action of shear force and are based on gelatine and gum arabic (250 mm to 3000 m diameter) may be used as active ingredient capsules (captivates hc encapsulates from Ashland).

As citric acid, a 5000 by weight aqueous solution is used.

As NaOH, a 4700 by weight aqueous solution is used.

### Example 1

Test series:

| | Base mixture (active proportions of the | | | |
|---|---|---|---|---|
| | respective component in % by weight) | | | |
| Component | V1 | V2 | V3 | I1 |
| diRL | 1.27 | — | 0.6235 | — |
| monoRL | — | 1.27 | 0.6235 | — |
| GL | — | — | — | 1.27 |
| TINOPAL CBS-X | 0.03 | 0.03 | 0.03 | 0.03 |
| LAS | 2.35 | 2.35 | 2.35 | 2.35 |
| CAPB | 2.00 | 2.00 | 2.00 | 2.00 |
| Citric acid | 0.24 | 0.24 | 0.24 | 0.24 |
| TEA | 0.89 | 0.89 | 0.89 | 0.89 |
| SLES 3EO | 7.05 | 7.05 | 7.05 | 7.05 |
| HP20 | 1.00 | 1.00 | 1.00 | 1.00 |
| NaOH | 0.30 | 0.30 | 0.30 | 0.30 |
| Texcare | 0.13 | 0.13 | 0.13 | 0.13 |
| BIT | 0.02 | 0.02 | 0.02 | 0.02 |
| Perfume | 0.45 | 0.45 | 0.45 | 0.45 |
| MIT | 0.10 | 0.10 | 0.10 | 0.10 |
| NaCl | 0.5 | 0.5 | 0.5 | 0.5 |
| MgSO₄ | 0.5 | 0.5 | 0.5 | 0.5 |
| H₂O | to 100 | to 100 | to 100 | to 100 |
| (demineralized) | | | | |

The respective base mixture V1, V2, V3 and I1 is adjusted to the desired pH by addition of further citric acid/NaOH.

Mixtures having a pH of 3.0, 3.25, 3.5, 3.75, 4.0, 4.24, 4.5, 5.0, 5.25, 5.5, 5.75, 6.0, 6.25, 6.5, 6.75, 7.0, are produced for each base mixture.

Within the context of the present invention, the exact viscosities can also be determined at 25° C. by viscosity measurements using an Anton Paar ASC Rheometer. The viscosities mentioned within the context of the invention are dynamic viscosities which are reported with the unit “m*Pa”=cPs (“centipoise”).

A much simpler protocol for assessing whether the base mixture adjusted to the respective pH has the desired viscosity for a hand dishwashing detergent and where a “jump” in viscosity takes place is as follows:

50 ml of the mixture to be tested are filled into a commercially available PET dishwashing detergent bottle with outlet valve (screw cap with folding hinge) at 25° C.

This bottle is closed and hung upside down in a holder over a beaker. A coarse needle is used to drill two holes in the bottom of the bottle (as air equalization).

The same bottle can also be reused for further tests, with the holes being sealed with adhesive tape when it is not upside down.

The viscosity of the respective mixture is inversely proportional to the amount of mixture that has flowed into the beaker after a certain period of time, or proportional to the time needed for the entire mixture to flow from the bottle into the beaker.

The results of the tests are as follows:
the viscosity of the comparative mixtures V1, V2 and V3 in the pH range from 3.0 to 5.5 is significantly higher than in the pH range from 5.75 to 7.0;
the viscosity of the mixture I1 according to the invention in the pH range from 3.0 to 6.0 is significantly higher than in the pH range from 6.25 to 7.0;
the viscosity of the mixture I1 according to the invention in the pH range from 3.0 to 5.5 is significantly higher than the viscosity of the comparative mixtures V1, V2 and V3.

It is assumed that the “jump” in viscosity occurs at a pH that corresponds approximately to the pKₐ of the glucolipid (pKₐ~6.5) or of the rhamnolipid (pKₐ~5.6; see S. Joy et al., Bioprocess Biosyst Eng. 2019, 42, 1301-1315). The pKₐ of rhamnolipids tends to be somewhat lower than that of glucolipids. When the pH is crossed, a critical amount of negatively charged glucolipid anions or rhamnolipid anions is assumed to be reached, which then affect the viscosity accordingly.

1. A liquid cleaning composition R, comprising:
a) a surfactant combination T_{Comb},
wherein the surfactant combination T_{Comb} comprises the following constituents i., ii., iii.:
i. at least one amphoteric surfactant T_{Amph},
ii. at least one glucolipid G,
iii. at least one surfactant T* different from G, where T* is selected from the group consisting of nonionic surfactants and anionic surfactants,
wherein the proportion of the at least one glucolipid G in the surfactant combination T_{Comb} lies in the range from 1% by weight to 95% by weight, based in each case on the total weight of the surfactant combination T_{Comb},
b) water;
c) at least one polymer P_{C}, where P_{C} is selected from the group consisting of alkoxylated polyamine and polyester soil release polymer,
and wherein the liquid cleaning composition R has a pH in the range from 3.0 to 6.5.

2. The liquid cleaning composition R according to claim 1, wherein the at least one surfactant T* is an alcohol ethoxylate.

3. The liquid cleaning composition R according to claim 1, wherein the at least one amphoteric surfactant T_{Amph} is a betaine surfactant.

4. The liquid cleaning composition R according to claim 1, wherein the at least one surfactant T* is an anionic surfactant selected from the group consisting of linear alkylbenzenesulfonates, alkyl sulfates, alkyl ether sulfates, and alkyl ether carboxylates.

5. The liquid cleaning composition R according to claim 1, wherein the proportion of the surfactant combination T_{Comb} in the liquid cleaning composition R lies in the range from 5% by weight to 60% by weight, based on the total weight of the liquid cleaning composition R.

6. The liquid cleaning composition R according to claim 1, comprising:
0.001% by weight to 3% by weight of a perfume, based on the total weight of the liquid cleaning composition R.

7. The liquid cleaning composition R according to claim 1, wherein the proportion of water lies in the range from 30% by weight to 95% by weight, based on the total weight of the liquid cleaning composition R.

8. The liquid cleaning composition R according to claim 1, comprising:
at least one salt.

9. The liquid cleaning composition R according to claim 1, wherein the at least one polymer Pc is a polyester soil release polymer with a structure according to the following structural formula (II)*: 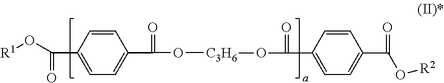
wherein in the chemical formula (II)* R¹ and R² are each independently selected from (i), (ii), (iii), and (iv):
(i): X—(OC₂H₄)ₙ—(OC₃H₆)ₘ—(*), in which X=C₁₋₄ alkyl;
(ii): X—(OC₃H₆)ₘ—(OC₂H₄)ₙ—(*), in which X=C₁₋₄ alkyl;
(iii): X—(OC₃H₆)ₘ—(*), in which X=C₁₋₄ alkyl;
(iv): X—(OC₂H₄)ₙ—(*), in which X=C₁₋₄ alkyl;
wherein the —(OC₂H₄) groups and the (OC₃H₆) groups in the radicals (i) and (ii) are present in blockwise or mixed form,
wherein “(*)” denotes the bond to the singly bonded oxygen of the respective “COO” group in the structure (II)*,
n=an integer in the range from 12 to 120,
m=an integer in the range from 1 to 10,
a=an integer in the range from 4 to 9.

10. The liquid cleaning composition R according to claim 1, wherein the at least one polymer Pc is an alkoxylated polyamine selected from the group consisting of alkoxylated polyethyleneimine and alkoxylated polypropyleneimine.

11. The liquid cleaning composition R according to claim 10, wherein the alkoxylated polyamine is prepared by an alkoxylation, and wherein the alkoxylation is selected from the group consisting of ethoxylation, propoxylation, and a mixture of the two.

12. A method, comprising:
increasing the viscosity of a liquid cleaning composition R having a pH in the range from 3.0 to 6.5 with at least one glucolipid G.

13. The method according to claim 12, wherein the liquid cleaning composition R comprises:
a) a surfactant combination T_{Comb},
wherein the surfactant combination T_{Comb} comprises the following constituents i., ii., iii.:
i. at least one amphoteric surfactant T_{Amph},
ii. at least one glucolipid G,
iii. at least one surfactant T* different from G, where T* is selected from the group consisting of nonionic surfactants and anionic surfactants,
wherein the proportion of the at least one glucolipid G in the surfactant combination T_{Comb} lies in the range from 1% by weight to 95% by weight, based in each case on the total weight of the surfactant combination T_{Comb},
b) water;
c) at least one polymer P_{C}, where P_{C} is selected from the group consisting of alkoxylated polyamine and polyester soil release polymer,
and wherein the liquid cleaning composition R has a pH in the range from 3.0 to 6.5.

14. A process for treating a substrate S with a wash liquor, the process comprising:
producing a wash liquor by mixing the liquid cleaning composition R according to claim 1 with water, and
contacting the wash liquor with the substrate S.

15. The process according to claim 14, wherein the substrate S is selected from the group consisting of an object, a part of the human body, and a part of an animal body.

16. The process according to claim 15, wherein the substrate S is an object selected from the group consisting of woven fabrics, nonwovens, and objects with hard surfaces.
